(19) United States
(12) Patent Application Publication
(10) Pub. No.: US 2018/0370061 A1
(43) Pub. Date: Dec. 27, 2018

(54) SLOTTER APPARATUS, AND SLOTTER POSITIONING METHOD, CARTON FORMER, AND CARDBOARD SHEET

(71) Applicant: MITSUBISHI HEAVY INDUSTRIES MACHINERY SYSTEMS, LTD., Hyogo (JP)

(72) Inventors: Kazutaka TOKUMO, Hiroshima (JP); Yasunari SUZUKI, Hiroshima (JP); Masayoshi TANCHI, Hiroshima (JP); Kazushige KUROKAWA, Hiroshima (JP)

(21) Appl. No.: 16/064,557

(22) PCT Filed: Oct. 7, 2016
(86) PCT No.: PCT/JP2016/079978

§ 371 Date: Jun. 21, 2018

(30) Foreign Application Priority Data
Dec. 24, 2015 (JP) 2015-252494

(51) Int. Cl. B26D 7/26; B31B 50/18; B31B 50/22; B31B 50/25; B31F 1/10

(52) U.S. Cl. CPC B26D 7/2635; B31B 50/18; D21F 11/12; B31B 50/25; B31F 1/10; B31B 50/22

(57) ABSTRACT

A slotter apparatus includes blade-attached slotter heads, receiving slotter heads, a drive device, a movement device, and a control device. The blade-attached slotter heads include slotter knives mounted on outer peripheral portions of the blade-attached slotter heads, are rotatably supported, and are disposed along a sheet transport direction. The receiving slotter heads are rotatably supported, are disposed to face the blade-attached slotter heads, and are disposed in the sheet transport direction in series. The drive device drivingly rotates the several blade-attached slotter heads and the receiving slotter heads. The movement device moves the blade-attached slotter heads and the receiving slotter heads in a rotational axis direction. The control device controls the drive device or the movement device when an adjustment mode in which each of the slotter knives is positioned at a predetermined position set in advance is selected.

### TECHNICAL FIELD

The present invention relates to a slotter apparatus and a slotter positioning method which performs slicing in a process of manufacturing a corrugated box, a carton-forming machine having a slotter apparatus, and a corrugated fiberboard.

### BACKGROUND ART

A general carton-forming machine manufactures a carton body (corrugated box) by processing a sheet material (for example, a corrugated fiberboard), and includes a sheet feeding section, a printing section, a slotter creaser section, a die-cut section, a folding section, and counter-ejector section. The corrugated fiberboards stacked on a table are fed to the printing section one by one at a constant speed by the sheet feeding section. The printing section includes a printing unit and performs printing on the corrugated fiberboard. The slotter creaser section forms creasing lines which become folding lines on the printed corrugated fiberboard and performs processing of grooves becoming flaps or gluing margin strips for joining. The die-cut section performs drilling for hand hole on the corrugated fiberboard on which the creasing lines, the grooves, and gluing margin strips are formed. The folding section applies glue to the gluing margin strip and folds the corrugated fiberboard on which the creasing lines, the grooves, the gluing margin strips, and the hand holes are formed along the creasing lines while moving the corrugated fiberboard, and joins the gluing margin strips to each other to manufacture a flat corrugated box. In addition, the counter-ejector section stacks the corrugated boxes in which corrugated fiberboards are folded and glued, sorts the stacked corrugated boxes into a predetermined number of batches, and discharges the sorted corrugated boxes.

Meanwhile, it is necessary to perform maintenance on the carton-forming machine on a regular basis, and in the slotter creaser section, a slotter head is moved to a retract position to secure a work space, a maintenance work is performed, and thereafter, the slotter head positioned at the retreat position is returned to an original position. In this case, if positional accuracy at the original position at which the slotter head is returned deteriorates, processing accuracy of the corrugated fiberboard processed after the slotter head is returned is damaged due to the deterioration. In addition, in the carton-forming machine, it is necessary to process several types of corrugated fiberboards having different sizes, and in the slotter creaser section, lengths or positions of the grooves and the gluing margin strips are different according to the size of corrugated fiberboard, and thus, the axial position of the slotter head or the circumferential position of the slotter knife is set to be adjustable. In this case, if adjustment positional accuracy of the slotter head or the slotter knife deteriorates, the processing accuracy of the corrugated fiberboard after the slotter head or the slotter knife is adjusted is damaged due to the deterioration.

However, adjusting the axial position of the slotter head or adjusting the circumferential position of the slotter knife according to the lengths or the positions of the grooves or the gluing margin strips is a hard work requiring a long time, and thus, productivity decreases. In addition, for example, as a carton-forming machine which can process several types of corrugated fiberboards, there is a carton-forming machine disclosed in PTL 1 below. In the carton-forming machine for the corrugated fiberboard disclosed in PTL 1, several slotters are provided, and a phase of the slotter knife of each slotter is adjusted.

### CITATION LIST

### Patent Literature

[PTL 1] Japanese Unexamined Patent Application Publication No. 2002-067190

### SUMMARY OF INVENTION

### Technical Problem

As described above, in the corrugated fiberboard, since the sizes of flaps or the gluing margin strips are different according to the size or the like, lengths of grooves or cut end portions processed by the slotter creaser section varies widely. Accordingly, it is required to improve efficiency of replacement works of the slotter knives or efficiency of position adjustment works of the slotter heads according to the lengths or positions of the grooves or the gluing margin strips of the corrugated fiberboard.

The present invention is made to solve the above-described problems, and an object thereof is to provide a slotter apparatus, a slotter positioning method, a carton-forming machine, and a corrugated fiberboard capable of improving the efficiency of position adjustment works of the slotters.

### Solution to Problem

In order to achieve the above-described object, according to the present invention, there is provided a slotter apparatus, including: several blade-attached slotter heads which include slotter knives mounted on outer peripheral portions of the blade-attached slotter heads, are rotatably supported, and are disposed along a sheet transport direction; several receiving slotter heads which are rotatably supported, are disposed to face the several blade-attached slotter heads, and are disposed in the sheet transport direction in series; a drive device which drivingly rotates the several blade-attached slotter heads and the several receiving slotter heads; a movement device which moves the several blade-attached slotter heads and the several receiving slotter heads in a rotational axis direction; and a control device which controls the drive device or the movement device when an adjustment mode in which each of the several slotter knives is positioned at a predetermined position set in advance is selected.

Accordingly, if the adjustment mode is selected, the control device moves each of the several slotter knives in the rotation axial direction or a circumferential direction of each of the several blade-attached slotter heads by the drive device or the movement device, and positions the slotter knife at the predetermined position set in advance. Therefore, it is possible to position each of the slotter knives at a desired position at an early stage, and it is possible to improve efficiency of a position adjustment work of the slotter.

In the slotter apparatus of the present invention, the drive device includes a first drive transmission system which drivingly rotates the blade-attached slotter heads, a second drive transmission system which drivingly rotates the receiving slotter heads, and a driving force disconnection unit which is provided in the first drive transmission system.

Accordingly, the drive device can drivingly rotate the blade-attached slotter heads by the first drive transmission system, can drivingly rotate the receiving slotter heads by the second drive transmission system, can stop driving rotations of the blade-attached slotter heads by the driving force disconnection unit, and can transport the sheet by the receiving slotter heads even when the rotations of the blade-attached slotter heads are stopped.

In the slotter apparatus of the present invention, the drive device includes several drive units which drivingly rotates the several blade-attached slotter heads independently.

Accordingly, the drive device drivingly rotates the blade-attached slotter heads independently, and thus, it is possible to select the blade-attached slotter head used according to a type of a sheet to be processed, and it is possible to improve versatility.

In the slotter apparatus of the present invention, the blade-attached slotter heads are supported to be moved relative to each other in the rotational axis direction and to be integrally rotated in a circumferential direction, the receiving slotter heads are supported to be moved relative to each other in the rotational axis direction and to be integrally rotated in the circumferential direction, the movement device includes movement adjusting members, each of which can be moved in a direction parallel to the rotational axis direction, and connection members which can connect the movement adjusting members, and the blade-attached slotter heads and the receiving slotter heads to each other.

Accordingly, the movement device can easily move the blade-attached slotter heads and the receiving slotter heads via the connection members in the axial direction by the movement adjusting member, and it is possible to improve workability when the positions of the blade-attached slotter heads and the receiving slotter heads are adjusted.

In the slotter apparatus of the present invention, the adjustment mode is an axial adjustment mode in which the several blade-attached slotter heads are moved to the same position as each other in the rotational axis direction by the movement device.

Accordingly, if the axial adjustment mode is selected, the control device moves the several blade-attached slotter heads to the same position as each other in the rotational axis direction by the movement device, and thus, when the several blade-attached slotter heads are moved to the work positions, it is possible to return each of the blade-attached slotter heads to a desired position at an early stage.

In the slotter apparatus of the present invention, in the axial adjustment mode, the control device moves blade-attached slotter heads other than a blade-attached slotter head disposed on the most upstream side in the sheet transport direction in the several blade-attached slotter heads to a movement position of the blade-attached slotter head disposed on the most upstream side, by the movement device.

Accordingly, the blade-attached slotter heads are moved to the movement position of the blade-attached slotter head disposed on the most upstream side in the sheet transport direction, and thus, it is possible to position the several blade-attached slotter heads according to the creasing line rolls, and it is possible to improve processing accuracy of the sheet.

In the slotter apparatus of the present invention, when each of the several blade-attached slotter heads is moved to a preset target position and a positional deviation in the rotational axis direction at each movement position of the several blade-attached slotter heads is not within a predetermined range set in advance, the control device moves other blade-attached slotter heads other than the blade-attached slotter head disposed on the most upstream side to the movement position of the blade-attached slotter head disposed on the most upstream side.

Accordingly, when the positional deviation of each of the several blade-attached slotter heads is large, the blade-attached slotter head is moved to the movement position of the blade-attached slotter head disposed on the most upstream side, and thus, movement errors of the several blade-attached slotter heads converge within a range of the movement error of one blade-attached slotter head, and it is possible to improve the positioning accuracy of each of the blade-attached slotter heads.

In the slotter apparatus of the present invention, the adjustment mode is a circumferential adjustment mode in which each of the several blade-attached slotter heads is rotated to an origin position, at which an end portion of the slotter knife is positioned at a sheet transport line, by the drive device.

Accordingly, if the circumferential adjustment mode is selected, the control device rotates the blade-attached slotter heads to the origin positions by the drive device, and thus, it is possible to position the slotter knives at desired positions at an early stage when the circumferential positions of the slotter knives are not known.

In the slotter apparatus of the present invention, in the circumferential adjustment mode, the control device moves one of the several blade-attached slotter heads to a predetermined position in the rotational axis direction by the movement device, drivingly rotates the several blade-attached slotter heads and the several receiving slotter heads by the drive device so as to slice the sheet, and rotates each of the several blade-attached slotter heads to the origin position based on a sheet processed shape.

Accordingly, the several blade-attached slotter heads are drivingly rotated and the sheet is sliced in a state where one blade-attached slotter head is moved to the predetermined position, and thus, the grooves processed by the slotter knives are individually formed on the sheet, and it is possible to ascertain the current circumferential position of each of the slotter knives with respect to the blade-attached slotter heads. In addition, each of the blade-attached slotter heads is rotated to the origin position, and thus, it is possible to easily position each of the slotter knives at the desired position after the blade-attached slotter head is rotated to the origin position.

In the slotter apparatus of the present invention, the control device stops a driving rotation performed by the drive device with respect to the blade-attached slotter head, which is not subjected to a position adjustment, in the several blade-attached slotter heads.

Accordingly, the driving rotation of the blade-attached slotter head which is not subjected to the position adjustment is stopped, and thus, the slicing by the blade-attached slotter head which is not trying to ascertain the circumferential position with respect to the sheet is not performed, and it is possible to process the groove of only the blade-attached slotter head which is trying to ascertain the circumferential position with respect to the sheet.

In the slotter apparatus of the present invention, after the control device positions each of the several slotter knives at a predetermined position, the control device drivingly rotates the several blade-attached slotter heads and the several receiving slotter heads by the drive device and trially slices a sheet.

Accordingly, after each of the several slotter knives is positioned at the predetermined position, the sheet is trially sliced, and thus, it is possible to check positioning accuracy of each of the slotter knives.

Moreover, according to the present invention, there is provided a slotter positioning method, including: a step of moving several slotter heads, which are positioned at work positions, in a rotational axis direction based on a target position data so as to move each of the several slotter heads to a target position; a step of determining whether or not a positional deviation in a rotational axis direction of each of the several slotter heads returned to the target positions is within a predetermined range set in advance; and a step of moving, when the positional deviation is not within the predetermined range, slotter heads other than a slotter head disposed on the most upstream side in the sheet transport direction in a rotational axis direction, based on a current position data of the slotter head disposed on the most upstream side.

Accordingly, when each of the several slotter heads positioned at the work positions is moved to the target position based on the target position data, if positional deviations occur in the several slotter heads, other slotter heads are moved to the current position of the slotter head disposed on the most upstream side.

Accordingly, the movement error of each of the slotter heads decreases, and thus, it is possible to accurately position each of the slotter knives at the desired position, and it is possible to improve the efficiency of the position adjustment work of each of the slotter knives.

In addition, according to the present invention, there is provided a slotter positioning method, including: a step of moving at least one slotter head of several slotter heads on which slotter knives are mounted to a work position offset in a rotational axis direction; a step of rotating the several slotter heads to slice the sheet; and a step of rotating, based on a sheet processed shape, at least the slotter head positioned at the work position to an origin position at which an end portion of the slotter knife is positioned at a sheet transport line.

Accordingly, if the several slotter heads are rotated to slice the sheet in a state where one slotter head is moved to the work position, a processing groove is formed on the sheet for each slotter knife, and the slotter head is rotated to the origin position according to the position of the processing groove. Therefore, it is possible to accurately position each of the slotter knives at a desired position based on the origin position, and it is possible to improve the efficiency of the position adjustment work of each of the slotter knives.

In addition, according to the present invention, there is provided a carton-forming machine including: a sheet feeding section which supplies a sheet; a printing section which performs printing on the sheet; a slotter creaser section having the slotter apparatus which performs creasing line processing and slicing on the printed sheet; a cutting section which cuts the sheet subjected to the creasing line processing and the slicing, at an intermediate position of the sheet in a transport direction; a folding section which folds the cut sheet and joins an end portion of the sheet to form a carton body; and a counter-ejector section which stacks the carton bodies while counting the carton bodies, and thereafter, discharges the carton bodies for each predetermined number.

Accordingly, printing is performed on the sheet, which is supplied from the sheet feeding section, in the printing section, and in the slotter creaser section, the creasing line processing and the slicing are performed on the sheet. Moreover, in the folding section, the sheet is folded, the end portions are joined to each other, and the carton body is formed. In addition, in the counter-ejector section, the carton bodies are stacked while being counted. In addition, beforehand, in the slotter apparatus, the several slotter knives are moved in the rotational axis direction or the circumferential direction of the blade-attached slotter head by the drive device or the movement device and are positioned at predetermined positions set in advance. Therefore, it is possible to position each of the slotter knives at a desired position at an early stage according to the size or the like of the sheet, and it is possible to improve the efficiency of the position adjustment work of each of the slotter knives.

Moreover, according to the present invention, there is provided a corrugated fiberboard, including: several creasing lines, several opening grooves, several through-grooves, and several gluing margin strips which are provided at preset positions, in which the opening groove or the through-groove is formed at a position other than the preset positions.

Accordingly, the opening groove or the through-groove is formed at the position other than the preset positions, and thus, it is possible to easily detect the current circumferential position of each of the slotter knives with respect to the blade-attached slotter heads.

### Advantageous Effects of Invention

According to the slotter apparatus, the slotter positioning method, the carton-forming machine, and the corrugated fiberboard of the present invention, the control device which controls the drive device or the movement device when the adjustment mode in which each of the several slotter knives is positioned at the predetermined position is selected is provided. Therefore, it is possible to position each of the slotter knives at a desired position at an early stage according to the size or the like of the sheet, and it is possible to improve the efficiency of the position adjustment work of the slotter.

### BRIEF DESCRIPTION OF DRAWINGS

FIG. 1 is a schematic configuration view showing a carton-forming machine of a first embodiment.

FIG. 2 is a schematic configuration view showing a slotter apparatus of the first embodiment.

FIG. 3 is an exploded perspective view showing the slotter apparatus.

FIG. 4 is a schematic configuration view showing a modification example of the slotter apparatus.

FIG. 5 is a schematic view showing a slotter position adjusting device.

FIG. 6 is a sectional view showing a slotter position adjusting device.

FIG. 7 is a schematic configuration view showing a driving system in the slotter apparatus.

FIG. 8 is a flowchart showing a slotter positioning method.

FIG. 9 is a schematic diagram of a slotter apparatus showing the arrangement of slotter knives when a single box sheet is processed.

FIG. 10 is a plan view showing the single box sheet.

FIG. 11 is a schematic view of the slotter apparatus showing an arrangement of slotter knives when a twin box sheet is processed.

FIG. 12 is a plan view showing the twin box sheet.

FIG. 13 is a schematic view for explaining phases of several slotter knives so as to process a communication groove.

FIG. 14 is a schematic view for explaining phases of the several slotter knives so as to process another communication groove.

FIG. 15 is a schematic view for explaining phases of the several slotter knives so as to process still another communication groove.

FIG. 16 is a schematic view of the slotter apparatus showing an arrangement of slotter knives when a triple box sheet is processed.

FIG. 17 is a plan view showing the twin box sheet.

FIG. 18 is a flowchart showing a slotter positioning method in a slotter apparatus of a second embodiment.

FIG. 19 is a plan view showing a corrugated fiberboard processed during indexing of first and third slotter knives.

FIG. 20 is a plan view showing the corrugated fiberboard processed after the indexing of first and third slotter knives.

FIG. 21 is a schematic view showing the indexed first slotter knife.

FIG. 22 is a schematic view showing the indexed third slotter knife.

FIG. 23 is a plan view showing the corrugated fiberboard processed during indexing of a second slotter knife.

FIG. 24 is a plan view showing the corrugated fiberboard processed after the indexing of the second slotter knife.

FIG. 25 is a schematic view showing the indexed second slotter knife.

### DESCRIPTION OF EMBODIMENTS

Preferred embodiments of a slotter apparatus, a slotter positioning method, a carton-forming machine, and a corrugated fiberboard according to the present invention will be described in detail with reference to the accompanying drawings. In addition, the present invention is not limited by the embodiment, and in a case where several embodiments are provided, the present invention includes those which are obtained by combining the embodiments.

### First Embodiment

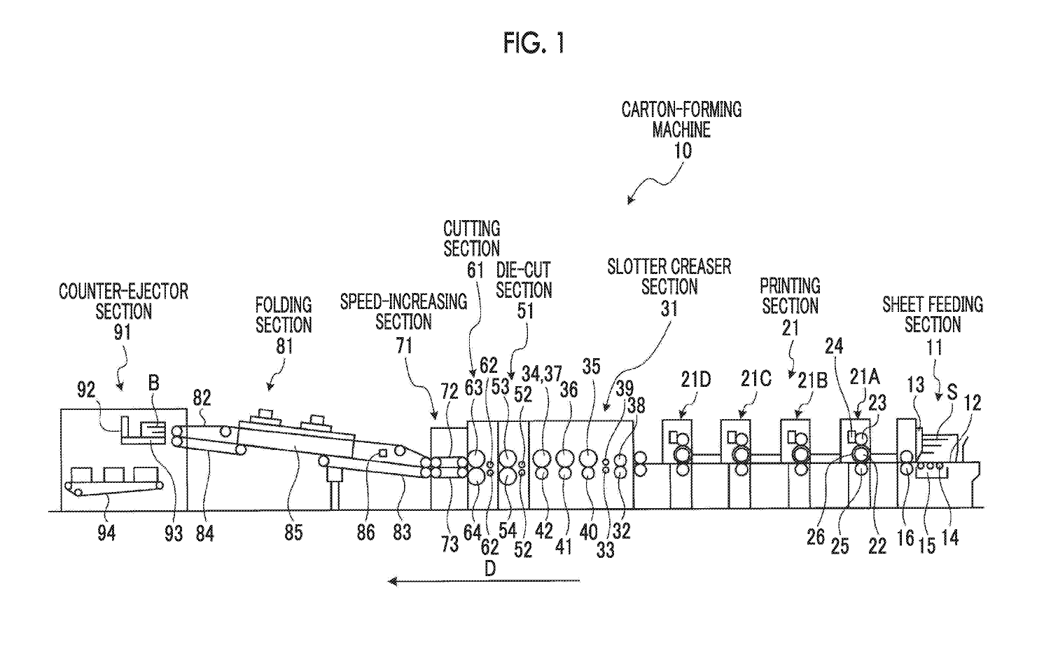

FIG. 1 is a schematic configuration view showing a carton-forming machine of the first embodiment.

In the first embodiment, as shown in FIG. 1, a carton-forming machine 10 manufactures a corrugated box (carton body) B by processing a corrugated fiberboard S. The carton-forming machine 10 includes a sheet feeding section 11, a printing section 21, a slotter creaser section 31, a die-cut section 51, a cutting section 61, a speed-increasing section 71, a folding section 81, and a counter-ejector section 91 which are linearly disposed in a direction D in which the corrugated fiberboard S and the corrugated box B are transported.

In the sheet feeding section 11, the corrugated fiberboards S are fed to the printing section 21 one by one at a constant speed. The sheet feeding section 11 includes a table 12, a front stopper 13, supply rollers 14, a suction unit 15, and a feed roll 16. Several corrugated fiberboards S are placed on the table 12 so as to be stacked, and the table 12 is supported so as to be lifted and lowered. The front stopper 13 can position the front end position of each of the corrugated fiberboards S stacked on the table 12, and a gap which allows one corrugated fiberboard S to pass through a portion between a lower end portion of the front stopper 13 and the table 12 is secured. Several supply rollers 14 are disposed corresponding to the table 12 in the transport direction D of the corrugated fiberboard S. When the table 12 is lowered, the corrugated fiberboard S located at the lowermost position in several stacked corrugated fiberboards S can be fed forward by the supply rollers 14. The stacked corrugated fiberboards S are suctioned downward, that is, toward the table 12 side or the supply roller 14 side by the suction unit 15. The feed roll 16 can provide the corrugated fiberboard S fed by the supply rollers 14 to the printing section 21.

The printing section 21 performs multi-color printing (in the first embodiment, four-color printing) on the surface of the corrugated fiberboard S. In the printing section 21, four printing units 21A, 21B, 21C, and 21D are disposed in series, and printing can be performed on the surface of the corrugated fiberboard S using four ink colors. The printing units 21A, 21B, 21C, and 21D are approximately similarly configured to each other, and each of the printing units 21A, 21B, 21C, and 21D includes a printing cylinder 22, an ink supply roll (anilox roll) 23, an ink chamber 24, and a receiving roll 25. A printing die 26 is mounted on the outer peripheral portion of the printing cylinder 22, and the printing cylinder 22 is rotatably provided. The ink supply roll 23 is disposed so as to contact against the printing die 26 in the vicinity of the printing cylinder 22, and is rotatably provided. The ink chamber 24 stores ink and is provided in the vicinity of the ink supply roll 23. The corrugated fiberboard S is interposed between the receiving roll 25 and the printing cylinder 22, the receiving roll 25 transports the corrugated fiberboard S while applying a predetermined printing pressure to the corrugated fiberboard S, and the receiving roll 25 is rotatably provided so as to face the lower portion of the printing cylinder 22. In addition, although not shown, a pair of upper and lower feed rolls is provided in front of and behind each of the printing units 21A, 21B, 21C, and 21D.

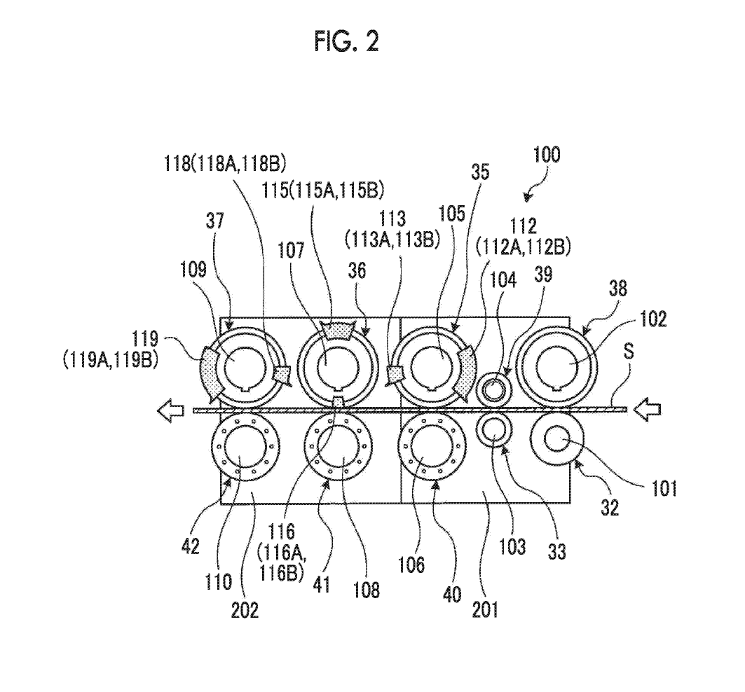

The slotter creaser section 31 includes a slotter apparatus 100 (refer to FIG. 2) and performs creasing line processing, cutting, slicing, and gluing margin strip processing on the corrugated fiberboard S. The slotter creaser section 31 includes first creasing line rolls 32, second creasing line rolls 33, a slitter head 34, first slotter heads 35, second slotter heads 36, and third slotter heads 37.

The first creasing line rolls 32 are circularly formed, and several first (four in the first embodiment) creasing lines rolls 32 are disposed at predetermined intervals in a horizontal direction orthogonal to the transport direction D of the corrugated fiberboard S. The second creasing line rolls 33 are circularly formed, and several second (four in the first embodiment) creasing line rolls 33 are disposed at predetermined intervals in the horizontal direction orthogonal to the transport direction D of the corrugated fiberboard S. The first creasing line rolls 32 disposed below perform the creasing line processing on a rear surface (lower surface) of the corrugated fiberboard S, and similarly to the first creasing line rolls 32, the second creasing line rolls 33 disposed below perform the creasing line processing on the rear surface (lower surface) of the corrugated fiberboard S. Receiving rolls 38 and 39 are provided at upper positions facing the creasing line rolls 32 and 33 so as to be rotatable in synchronization with the creasing line rolls 32 and 33.

The first slotter heads 35 are circularly formed, and first several (four in the first embodiment) slotter heads 35 are disposed at predetermined intervals in the horizontal direction orthogonal to the transport direction D of the corrugated fiberboard S. The first slotter heads 35 are provided to correspond to predetermined positions in a width direction of the transported corrugated fiberboard S, and thus, can perform slicing and gluing margin strip processing at the predetermined positions of the corrugated fiberboard S. The second slotter heads 36 are circularly formed, and second several (four in the first embodiment) slotter heads 36 are disposed at predetermined intervals in the horizontal direction orthogonal to the transport direction D of the corrugated fiberboard S. The second slotter heads 36 are provided to correspond to predetermined positions in the width direction of the transported corrugated fiberboard S, and thus, can perform slicing and gluing margin strip processing at the predetermined positions of the corrugated fiberboard S.

Each of the slitter head 34 and the third slotter heads 37 is circularly formed, and several (five in the first embodiment) heads which are one slitter head 34 and four third slotter heads 37 are disposed at predetermined intervals in the horizontal direction orthogonal to the transport direction D of the corrugated fiberboard S. One slitter head 34 is configured, is provided to correspond to the end portion in the width direction of the transported corrugated fiberboard S, and can cut the end portion in the width direction of the corrugated fiberboard S. Four third slotter heads 37 are configured, are provided to correspond to predetermined positions in the width direction of the transported corrugated fiberboard S, and can perform slicing and gluing margin strip processing at predetermined positions of the corrugated fiberboard S. Lower blades 40 are provided at lower positions facing the first slotter heads 35 so as to be rotatable in synchronization with the first slotter heads 35, lower blades 41 are provided at lower positions facing the second slotter heads 36 so as to be rotatable in synchronization with the second slotter heads 36, and lower blades 42 are provided at lower positions facing the slitter head 34 and the third slotter heads 37 so as to be rotatable in synchronization with the slitter head 34 and the third slotter heads 37.

In the die-cut section 51, drilling for forming a hand hole is performed on the corrugated fiberboard S. The die-cut section 51 includes a pair of upper and lower feed pieces 52, an anvil cylinder 53, and a knife cylinder 54. The feed pieces 52 are rotatably provided such that the corrugated fiberboard S is transported in a state where the corrugated fiberboard S is interposed between the upper portion and the lower portion. Each of the anvil cylinder 53 and the knife cylinder 54 is circularly formed, and the anvil cylinder 53 and the knife cylinder 54 are rotatable in synchronization with each other by a drive device (not shown). A head and a die are formed at predetermined positions of an outer peripheral portion of the knife cylinder 54 while an anvil is formed on an outer peripheral portion of the anvil cylinder 53.

The corrugated fiberboard S is cut to be two corrugated fiberboards at an intermediate position in the transport direction D by the cutting section 61. The cutting section 61 includes a pair of upper and lower feed pieces 62 and a pair of upper and lower cutting rolls 63 and 64. The feed pieces 62 are rotatably provided such that the corrugated fiberboard S is transported in a state where the corrugated fiberboard S is interposed between the upper portion and the lower portion. Each of the cutting rolls 63 and 64 is circularly formed, and the cutting rolls 63 and 64 are rotatable in synchronization with each other by a drive device (not shown). A cutting blade is fixed to each of the cutting rolls 63 and 64 at a predetermined position of the outer peripheral portion of each of the cutting rolls 63 and 64.

The speed-increasing section 71 increases a speed of the cut corrugated fiberboard S, and thus, a predetermined transport interval between the transported corrugated fiberboards S is secured by the speed-increasing section 71. The speed-increasing section 71 includes a pair of upper and lower transport belts 72 and 73. The transport belts 72 and 73 can be rotated by a drive device (not shown) in synchronization with the each other such that the corrugated fiberboard S is transported in a state where the corrugated fiberboard S is interposed between the upper portion and the lower portion. A transport speed of the corrugated fiberboard S in the speed-increasing section 71 is set to a faster speed than a transport speed of the corrugated fiberboard S up to the cutting section 61.

In the folding section 81, the corrugated fiberboard S is folded while being moved in the transport direction D, and both end portions of the corrugated fiberboard S in the width direction are joined to each other so as to form a flat corrugated box B. The folding section 81 includes an upper transport belt 82, lower transport belts 83 and 84, and a forming device 85. The upper transport belt 82 and the lower transport belts 83 and 84 transport the corrugated fiberboard S and the corrugated box B in a state where the corrugated fiberboard S and the corrugated box B interposed between the upper portion and the lower portion. The forming device 85 includes a pair of right and left forming belts, and end portions in the width direction of the corrugated fiberboard S are folded while being bent downward by the forming belts. In addition, the folding section 81 includes a gluing device 86. The gluing device 86 includes a glue gun, glue is ejected at a predetermined timing by the glue gun, and gluing can be applied to a predetermined position of the corrugated fiberboard S.

In the counter-ejector section 91, after the corrugated boxes B are stacked while being counted, the corrugated boxes B are sorted into a predetermined number of batches, and thereafter, the sorted corrugated boxes B are discharged. The counter-ejector section 91 includes a hopper device 92. The hopper device 92 includes an elevator 93 on which corrugated boxes B are stacked and which can be lifted and lowered, and a front stopper and an angle arrangement plate are provided in the elevator 93. In addition, an ejection conveyor 94 is provided below the hopper device 92.

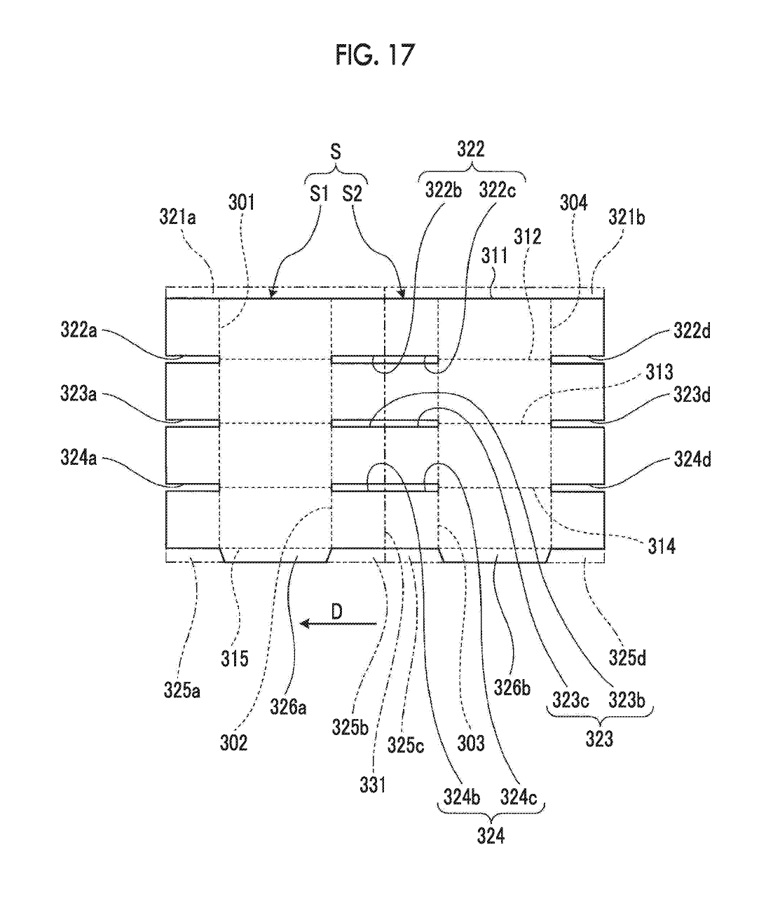

Here, in the carton-forming machine of the above-described first embodiment, an operation for manufacturing the corrugated box B from the corrugated fiberboard S is described. In the carton-forming machine of the first embodiment, after printing, creasing line processing, processing of grooves and gluing margin strips, and drilling are performed on two corrugated fiberboards S (S1 and S2) in a state where the two corrugated fiberboards S are connected to each other, the corrugated fiberboard is cut to be the two corrugated fiberboards S1 and S2, and the corrugated fiberboards S1 and S2 are folded so as to manufacture the corrugated box B. FIG. 17 is a plan view showing a twin box sheet.

The corrugated fiberboard (twin box sheet) S is formed by gluing a medium forming a waveform between a bottom liner and a top liner. As shown in FIG. 17, in the corrugated fiberboard S, four folding lines 301, 302, 303, and 304 are formed in a pre-process of the carton-forming machine 10. The folding lines 301, 302, 303, and 304 are used for folding a flap when the corrugated box B manufactured by the carton-forming machine 10 is assembled later. As shown in FIG. 1, the corrugated fiberboard S is stacked on the table 12 of the sheet feeding section 11.

In the sheet feeding section 11, first, the several corrugated fiberboards S stacked on the table 12 are positioned by the front stopper 13, and thereafter, the table 12 is lowered, the corrugated fiberboard S positioned at the lowermost position is fed by several supply rollers 14. Accordingly, the corrugated fiberboard S is supplied to the printing section 21 on a predetermined side by the pair of feed rolls 16.

In the printing section 21, ink is supplied from the ink chamber 24 to the surface of the ink supply roll 23 in each of the printing units 21A, 21B, 21C, and 21D, and if the printing cylinder 22 and the ink supply roll 23 rotate, the ink on the surface of the ink supply roll 23 is transferred to the printing die 26. If the corrugated fiberboard S is transported to a portion between the printing cylinder 22 and the receiving roll 25, the corrugated fiberboard S is interposed between the printing die 26 and the receiving roll 25, and a printing pressure is applied to the corrugated fiberboard S so as to perform printing on the surface of the corrugated fiberboard S. The printed corrugated fiberboard S is transported to the slotter creaser section 31 by the feed rolls.

In the slotter creaser section 31, first, when the corrugated fiberboard S passes through the first creasing line rolls 32, as shown in FIG. 17, creasing lines 312, 313, 314, and 315 are formed on the rear surface (top liner) side of the corrugated fiberboard S. In addition, when the corrugated fiberboard S passes through the second creasing line rolls 33, similarly to the first creasing line rolls 32, the creasing lines 312, 313, 314, and 315 are formed on the rear surface (top liner) side of the corrugated fiberboard S again.

Next, when the corrugated fiberboard S in which the creasing lines 312, 313, 314, and 315 are formed passes through the slitter head 34, end portions 321a and 321b are cut at the position of a cut position 311. In addition, when the corrugated fiberboard S passes through the first, second, and third slotter heads 35, 36, and 37, grooves 322a, 322b, 322c, 322d, 323a, 323b, 323c, 323d, 324a, 324b, 324c, and 324d are formed at the positions of the creasing lines 312, 313, and 314. In this case, end portions 325a, 325b, 325c, and 325d are cut at the position of the creasing line 315, and gluing margin strips 326a and 326b are formed.

Moreover, although it is described later, the grooves 322d, 323d, and 324d are formed when the corrugated fiberboard S passes through the first slotter heads 35, the grooves 322a, 323a, and 324a are formed when the corrugated fiberboard S passes through the third slotter heads 37, and the grooves 322b, 322c, 323b, 323c, 324b, and 324c when the corrugated fiberboard S passes through the first, second, and third slotter heads 35, 36, and 37 stepwise. Here, the grooves 322b, 322c, 323b, 323c, 324b, and 324c are communication grooves 322, 323, and 324, and the grooves 322a, 322d, 323a, 323d, 324a, and 324d are opening grooves. Thereafter, as shown in FIG. 1, the corrugated fiberboard S is transported to the die-cut section 51.

In the die-cut section 51, when the corrugated fiberboard S passes through a portion between the anvil cylinder 53 and the knife cylinder 54, a hand hole (not shown) is formed. However, since the hand hole processing is appropriately performed according to the kind of the corrugated fiberboard S, when the hand hole is not required, a blade attachment base (punching blade) for performing the hand hole processing is removed from the knife cylinder 54, and the corrugated fiberboard S passes through a portion between the rotating anvil cylinder 53 and knife cylinder 54. In addition, the corrugated fiberboard S in which the hand hole is formed is transported to the cutting section 61.

In the cutting section 61, when the corrugated fiberboard S passes through a portion between the upper and lower cutting rolls 63 and 64, as shown in FIG. 17, the corrugated fiberboard S is cut at a cut position 331. Accordingly, the corrugated fiberboard S is cut to be the corrugated fiberboard S1 in which the grooves 322a, 322b, 323a, 323b, 324a, and 324b and the gluing margin strip 326a are formed, and the corrugated fiberboard S2 in which the grooves 322c, 322d, 323c, 323d, 324c, and 324d and the gluing margin strip 326b are formed. In addition, as shown in FIG. 1, the corrugated fiberboards S1 and S2 are sequentially transported to the speed-increasing section 71.

In the speed-increasing section 71, the cut corrugated fiberboards S1 and S2 are transported while being interposed between the upper and lower transport belts 72 and 73. In this case, since the corrugated fiberboards S1 and S2 are transported at a transport speed which is increased from the transport speed of the cutting section 61, a predetermined transport interval is formed between the corrugated fiberboards S1 and S2. Thereafter, the corrugated fiberboard S is transported to the folding section 81.

In the folding section 81, glue is applied to the gluing margin strip 326a (326b) by the gluing device 86 while the corrugated fiberboard S1 (S2) is moved in the transport direction D by the upper transport belt 82 and the lower transport belts 83 and 84, and thereafter, the corrugated fiberboards S1 (S2) is folded downward by the forming device 85 with the creasing lines 312 and 314 as base points. If this folding advances to nearly 1800, the folding force becomes stronger, the gluing margin strip 326a (326b) and the end portion of the corrugated fiberboard S1 (S2) are pressed to each other so as to come into close contact with each other, both end portions of the corrugated fiberboard S1 (S2) are joined to each other, and the corrugated box B is formed. In addition, as shown in FIG. 1, the corrugated box B is transported to the counter-ejector section 91.

In the counter-ejector section 91, the corrugated box B is fed to the hopper device 92, the tip portion of the corrugated box B in the transport direction D abuts on the front stopper, and the corrugated boxes B is stacked on the elevator 93 in a state of being arranged by the angle arrangement plate. In addition, if a predetermined number of corrugated boxes B are stacked on the elevator 93, the elevator 93 is lowered, a predetermined number of corrugated boxes B become one batch, are discharged by the ejection conveyor 94, and are fed to the post-process of the carton-forming machine 10.

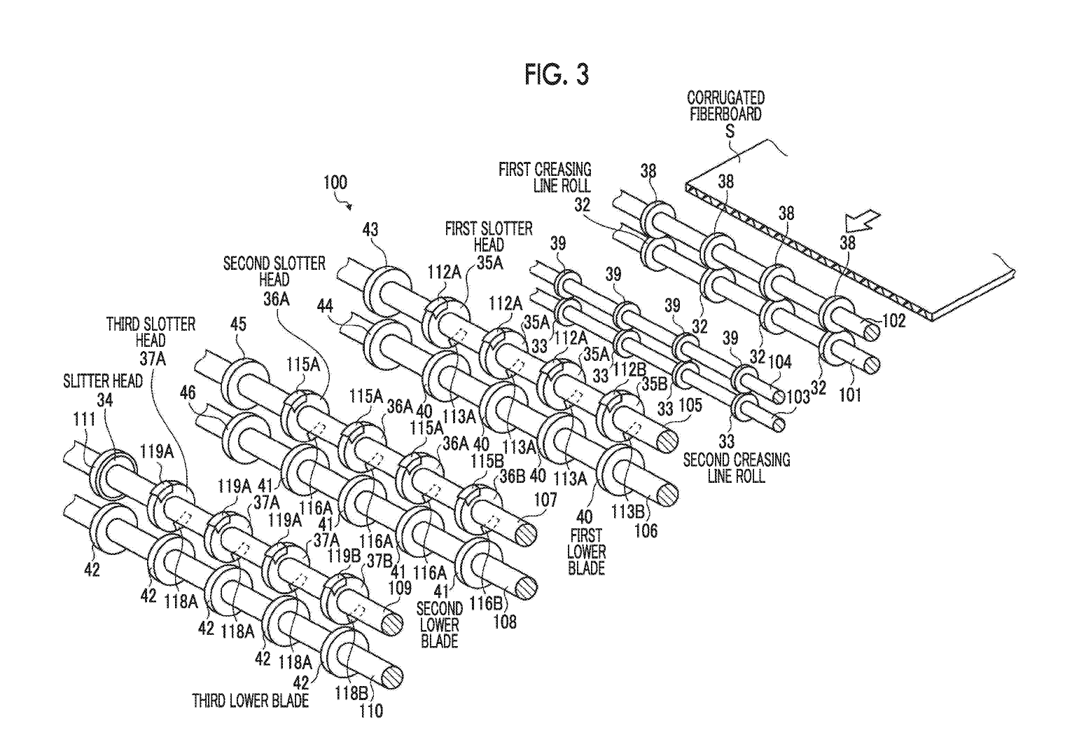

Here, the slotter creaser section 31 having the slotter apparatus of the first embodiment will be described in detail. FIG. 2 is a schematic configuration view showing the slotter apparatus of the first embodiment and FIG. 3 is a perspective view showing the slotter apparatus.

As shown in FIGS. 2 and 3, the slotter creaser section 31 includes the slotter apparatus 100. The slotter apparatus 100 performs the creasing line processing, the cutting, the slicing, and the gluing margin strip processing on the corrugated fiberboard S.

The slotter apparatus 100 is configured of the first creasing line rolls 32, the receiving rolls 38, the second creasing line rolls 33, the receiving rolls 39, the first slotter heads (blade-attached slotter heads) 35, the first lower blades (receiving slotter heads) 40, the second slotter heads (blade-attached slotter heads) 36, the second lower blades (receiving slotter heads) 41, the slitter head 34, the third slotter heads (blade-attached slotter heads) 37, and the third lower blades (receiving slotter heads) 42.

Here, the first creasing line rolls 32 and the receiving rolls 38, the second creasing line rolls 33 and the receiving rolls 39, the first slotter heads 35 and the first lower blades 40, the second slotter heads 36 and the second lower blades 41, the slitter head 34, the third slotter heads 37, and third lower blades 42 are disposed in series at predetermined intervals in the transport direction D of the corrugated fiberboard S.

In upper and lower roll shafts 101 and 102, each end portion is rotatably supported by a frame (not shown), the four first creasing line rolls 32 are fixed to the lower roll shaft 101 at predetermined intervals in an axial direction, and the four receiving rolls 38 are fixed to the upper roll shaft 102 at predetermined intervals in an axial direction. In addition, in upper and lower roll shafts 103 and 104, each end portion is rotatably supported by the frame (not shown), the four second creasing line rolls 33 are fixed to the lower roll shaft 103 at predetermined intervals in an axial direction, and the four receiving rolls 39 are fixed to the upper roll shaft 104 at predetermined intervals in an axial direction.

In this case, each first creasing line roll 32 and each receiving roll 38 are disposed to face each other vertically, and each second creasing line roll 33 and each receiving roll 39 are disposed to face each other vertically. In addition, each second creasing line roll 33 is disposed with a predetermined gap in a horizontal direction on the downstream of each first creasing line roll 32. Moreover, the first creasing line rolls 32 and the second creasing line rolls 33 are disposed at the same position as each other in the axial directions of the roll shafts 101 and 103, and diameters of the second creasing line rolls 33 are set to be smaller than diameters of the first creasing line rolls 32.

Accordingly, the first creasing line rolls 32 and the receiving rolls 38 are disposed to face each other vertically, and if the corrugated fiberboard S enters portions between the first creasing line rolls 32 and the receiving rolls 38, the corrugated fiberboard S is interposed between the outer peripheral portions of the first creasing line rolls 32 and the outer peripheral portions of the receiving rolls 38, and creasing lines are formed on the lower surface of the corrugated fiberboard S when the corrugated fiberboard S passes through the portions between the outer peripheral portions of the first creasing line rolls 32 and the outer peripheral portions of the receiving rolls 38. In addition, the second creasing line rolls 33 and the receiving rolls 39 are disposed to face each other vertically, and if the corrugated fiberboard S enters portions between the second creasing line rolls 33 and the receiving rolls 39, the corrugated fiberboard S is interposed between the outer peripheral portions of the second creasing line rolls 33 and the outer peripheral portions of the receiving rolls 39, and creasing lines are formed on the lower surface of the corrugated fiberboard S again when the corrugated fiberboard S passes through the portions between the outer peripheral portions of the second creasing line rolls 33 and the outer peripheral portions of the receiving rolls 39. In this case, since the first creasing line roll 32 and the second creasing line roll 33 roll at the same position, one creasing line is formed on the corrugated fiberboard S.

Moreover, in upper and lower slotter shafts (rotating shafts) 105 and 106, each end portion is rotatably supported by the frame (not shown), the four first slotter heads 35 (35A and 35B) and one feed roller 43 are fixed to the upper slotter shaft 105 at predetermined intervals in an axial direction, and the four first lower blades 40 and one feed roller 44 are fixed to the lower slotter shaft 106 at predetermined intervals in an axial direction. In this case, the four first lower blades 40 are disposed to correspond to the four first slotter heads 35 vertically and the feed rollers 43 and 44 are disposed vertically. In addition, in upper and lower slotter shafts 107 and 108, each end portion is rotatably supported by the frame (not shown), the four second slotter heads 36 (36A and 36B) and one feed roller 45 are fixed to the upper slotter shaft 107 at predetermined intervals in an axial direction, and the four second lower blades 41 and one feed roller 46 are fixed to the lower slotter shaft 108 at predetermined intervals in an axial direction. In addition, in upper and lower slotter shafts 109 and 110, each end portion is rotatably supported by the frame (not shown), one slitter head 34 and the four third slotter heads 37 (37A and 37B) are fixed to the upper slotter shaft 109 at predetermined intervals in an axial direction, and the five third lower blades 42 are fixed to the lower slotter shaft 110 at predetermined intervals in an axial direction.

In addition, a first slotter knife 112 (112A) and a second slotter knife 113 (113A) are mounted on the outer peripheral portion of each of the three first slotter heads 35A, and a first slotter knife 112 (112B) and a second slotter knife 113 (113B) are mounted on the outer peripheral portion of the one first slotter head 35B. Moreover, a third slotter knife 115 (115A) and a fourth slotter knife 116 (116A) are mounted on the outer peripheral portion of each of the three second slotter heads 36A, and a third slotter knife 115 (115B) and a fourth slotter knife 116 (116B) are mounted on the outer peripheral portion of the one second slotter head 36B. In addition, a slitter knife 111 is mounted on the outer peripheral portion of one slitter head 34, a fifth slotter knife 118 (118A) and a sixth slotter knife 119 (119A) are mounted on the outer peripheral portion of each of the three third slotter heads 37A, and a fifth slotter knife 118 (118B) and a sixth slotter knife 119 (119B) are mounted on the outer peripheral portion of the one third slotter head 37B.

The slitter head 34 is used as a head for cutting an end portion which cuts one end portion in the width direction of the corrugated fiberboard S, and in FIG. 17, the slitter knife 111 can cut the end portions 321a and 321b at the cut position 311. Returning to FIGS. 2 and 3, the slitter knife 111 is provided on the entire circumference of the slitter head 34.

The three first slotter heads 35A, the three second slotter heads 36A, and the three third slotter heads 37A are used for slicing to form grooves on the corrugated fiberboard S in the transport direction D, and in FIG. 17, can form the grooves 322a, 322b, 322c, 322d, 323a, 323b, 323c, 323d, 324a, 324b, 324c, and 324d. Returning to FIGS. 2 and 3, the first slotter knife 112A and the second slotter knife 113A are provided on a portion of each of the first slotter heads 35A in the circumferential direction to be arranged in the circumferential direction. The third slotter knife 115A and the fourth slotter knife 116A are provided on a portion of each of the second slotter heads 36A in the circumferential direction to be arranged in the circumferential direction. The fifth slotter knife 118A and the sixth slotter knife 119A are provided on a portion of each of the third slotter heads 37A in the circumferential direction to be arranged in the circumferential direction.

The one first slotter head 35B, the one second slotter head 36B, and the one third slotter head 37B are disposed on the end portions of the slotter shafts 105, 107, and 109, are used for gluing margin strip processing by which the other end portion in the width direction of the corrugated fiberboard S is cut to form a gluing margin strip, and in FIG. 17, can cut the end portions 325a, 325b, 325c, and 325d to form the gluing margin strips 326a and 326b. Returning to FIGS. 2 and 3, the first slotter knife 112B and the second slotter knife 113B are provided on a portion of the first slotter head 35B in the circumferential direction to be arranged in the circumferential direction. The third slotter knife 115B and the fourth slotter knife 116B are provided on a portion of the second slotter head 36B in the circumferential direction to be arranged in the circumferential direction. The fifth slotter knife 118B and the sixth slotter knife 119B are provided on a portion of the third slotter head 37B in the circumferential direction to be arranged in the circumferential direction.

Although not shown, each of the slotter knives 112B, 113B, 115B, 116B, 118B, and 119B is configured of a first cutting edge and a second cutting edge which are disposed in a direction approximately orthogonal to each other. The first cutting edge is mounted on each of the slotter heads 35B, 36B, and 37B in the transport direction D of the corrugated fiberboard S, and the second cutting edge is mounted on each of the slotter heads 35B, 36B, and 37B in the width direction intersecting the transport direction D of the corrugated fiberboard S. Accordingly, the first cutting edge and the second cutting edge are disposed to be formed in an L shape and cut the other end portion in the width direction of the corrugated fiberboard S into an L shape, and in FIG. 17, can cut the end portions 325a, 325b, 325c, and 325d.

In this case, the first slotter heads 35 (35A and 35B) and the first lower blades 40 are disposed so as to respectively face each other vertically, the second slotter heads 36 (36A and 36B) and the second lower blades 41 are disposed so as to respectively face each other vertically, and the slitter head 34 and the third slotter heads 37 (37A and 37A) and the third lower blades 42 are disposed so as to respectively face each other vertically. In addition, the first slotter heads 35 (35A and 35B) are disposed with predetermined gaps in the horizontal direction on the downstream sides of the second creasing line rolls 33, the second slotter heads 36 (36A and 36B) are disposed with predetermined gaps in the horizontal direction on the downstream sides of the first slotter heads 35 (35A and 35B), and the slitter head 34 and the third slotter heads 37 (37A and 37B) are disposed with predetermined gaps in the horizontal direction on the downstream sides of the second slotter heads 36 (36A and 36B). Moreover, the second creasing line rolls 33 and the first slotter heads 35 (35A and 35B) are disposed at the same position as each other in the axial directions of the shafts 103 and 105, the first slotter heads 35 (35A and 35B) and the second slotter heads 36 (36A and 36B) are disposed at the same position as each other in the axial directions of the slotter shafts 105 and 107, and the second slotter heads 36 (36A and 36B) and the third slotter heads 37 (37A and 37) are disposed at the same position as each other in the axial directions of the slotter shafts 107 and 109.

In the above descriptions, the slotter apparatus 100 is configured of the first creasing line rolls 32, the receiving rolls 38, the second creasing line rolls 33, the receiving rolls 39, the first slotter heads 35, the first lower blades 40, the second slotter heads 36, the second lower blades 41, the slitter head 34, the third slotter heads 37, and the third lower blades 42. However, the slotter apparatus 100 is not limited to this configuration.

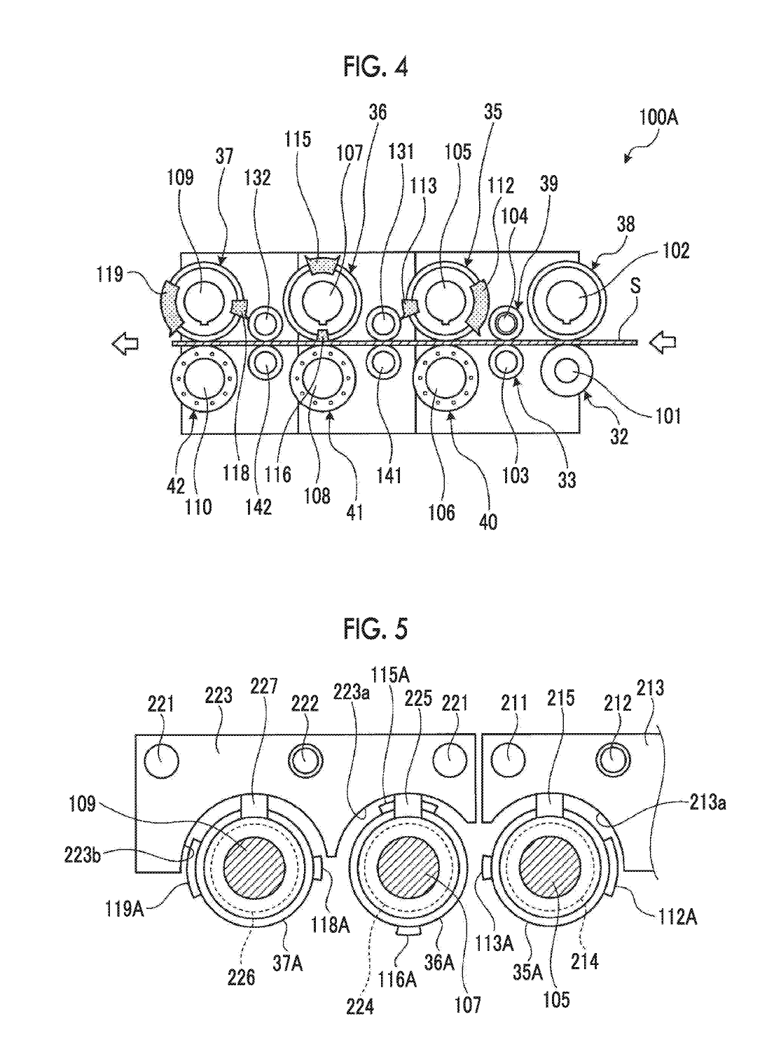

FIG. 4 is a schematic configuration view showing a modification example of the slotter apparatus. As shown in FIG. 4, a slotter apparatus 100A is configured of the first creasing line rolls 32, the receiving rolls 38, the second creasing line rolls 33, the receiving rolls 39, the first slotter heads 35, the first lower blades 40, a pair of upper and lower first feed pieces (transport unit) 141, the second slotter heads 36, the second lower blades 41, a pair of upper and lower second feed pieces (transport unit) 142, the slitter head 34, the third slotter heads 37, and the third lower blades 42.

Here, the slotter knives 112, 113, 115, 116, 118, and 119 mounted on the slotter heads 35, 36, and 37 will be described in detail.

As shown in FIG. 2, each of the slotter knives 112, 113, 115, 116, 118, and 119 is mounted on the outer peripheral portion of each of the slotter heads 35, 36, and 37, and each of outer edges of the slotter knives is formed in an arc shape. In addition, as shown in FIGS. 2 and 17, when the first slotter heads 35 are rotated, the first slotter knives 112 form the grooves 322d, 323d, 324d, which are opening grooves, on the upstream end portion of the corrugated fiberboard S in the transport direction D, and cut the end portion 325d. In addition, when the third slotter heads 37 are rotated, the sixth slotter knives 119 form the grooves 322a, 323a, 324a, which are opening grooves, on the downstream end portion of the corrugated fiberboard S in the transport direction D, and cut the end portion 325a. Moreover, when the first, second, and third slotter heads 35, 36, and 37 are rotated, at least two slotter knives of the second slotter knife 113, the third slotter knife 115, the fourth slotter knife 116, and the fifth slotter knife 118 form communication grooves 322, 323, and 324 (grooves 322b, 322c, 323b, 323c, 324b, and 324c) at the intermediate portion of the corrugated fiberboard S in the transport direction D, and cut the end portions 325b and 325c.

Accordingly, as shown in FIG. 2, in the first slotter head 35, a circumferential length of the first slotter knife 112 is set to be longer than a circumferential length of the second slotter knife 113. In the third slotter head 37, a circumferential length of the sixth slotter knife 119 is set to be longer than a circumferential length of the fifth slotter knife 118.

Here, the circumferential length of the first slotter knife 112 and the circumferential length of the sixth slotter knife 119 are set to be the same as each other, and the circumferential length of the second slotter knife 113 and the circumferential length of the fifth slotter knife 118 are set to be the same as each other.

Moreover, in the second slotter head 36, a circumferential length of the third slotter knife 115 is set to be longer than the circumferential length of a fourth slotter knife 116. In addition, the circumferential length of each of the second slotter knife 113 and the fifth slotter knife 118 is set to be shorter than the circumferential length of the third slotter knife 115 and is set to be longer than the circumferential length of the fourth slotter knife 116.

Moreover, the second slotter knife 113 is fixed to the outer peripheral portion of the first slotter head 35, the third slotter knife 115 is fixed to the outer peripheral portion of the second slotter head 36, and the sixth slotter knife 119 is fixed to the outer peripheral portion of the third slotter head 37. Meanwhile, the first slotter knife 112 is mounted on the outer peripheral portion of the first slotter head 35 so as to be adjustable in position in the circumferential direction, the fourth slotter knife 116 is mounted on the outer peripheral portion of the second slotter head 36 so as to be adjustable in position in the circumferential direction, and the fifth slotter knife 118 is mounted on the outer peripheral portion of the third slotter head 37 so as to be adjustable in position in the circumferential direction. Here, the fixing is performed by bolt-fastening, welding, or the like and the position being adjustable means that the position is freely movable in the circumferential direction by a rail or an elongated hole.

In addition, in the slotter apparatus 100, the first creasing line rolls 32, the receiving rolls 38, the second creasing line rolls 33, the receiving rolls 39, the first slotter heads 35, and the first lower blades 40 are supported between a pair of first frames 201 on an upstream side in the transport direction of the corrugated fiberboard S, and the second slotter heads 36, the second lower blades 41, the slitter head 34, the third slotter heads 37, and the third lower blades 42 are supported between a pair of second frames 202 on a downstream side in the transport direction of the corrugated fiberboard S.

In addition, the first creasing line rolls 32, the receiving rolls 38, the second creasing line rolls 33, the receiving rolls 39, the first slotter heads 35, and the first lower blades 40 are movable in a rotational axis direction (the width direction of the corrugated fiberboard S) with respect to the first frames 201 and can be positioned at predetermined positions. Moreover, the second slotter heads 36, the second lower blades 41, the slitter head 34, the third slotter heads 37, and the third lower blades 42 are movable in the rotational axis direction (the width direction of the corrugated fiberboard S) with respect to the second frames 202 and can be positioned at predetermined positions.

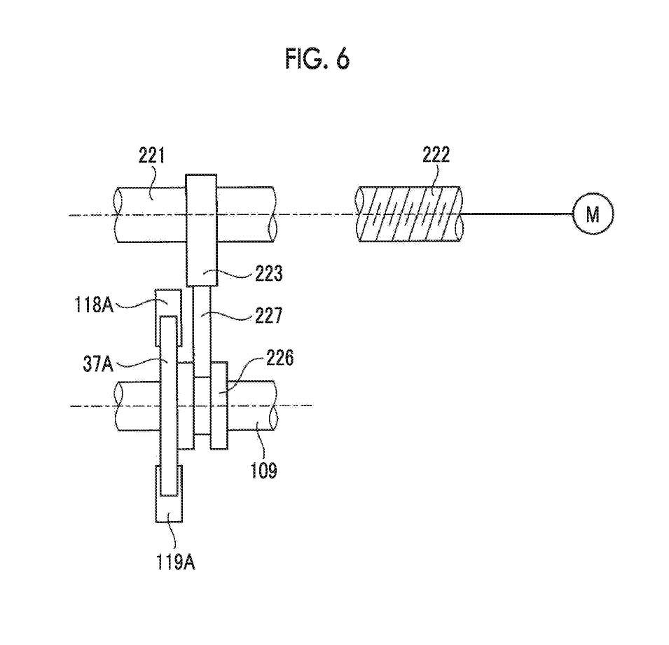

FIG. 5 is a schematic view showing a slotter position adjusting device and FIG. 6 is a sectional view showing the slotter position adjusting device. Here, FIG. 5 is a sectional view at the positions of the slotter heads 35A, 36A, and 37A positioned on the most right-sides in the rotational axis direction in FIG. 2, and FIG. 6 is a sectional view at the positions of a supporting shaft, a screw shaft, and the third slotter head 37A in FIG. 5.

As shown in FIGS. 5 and 6, the first slotter head 35A is movable in the axial direction (movable relative to) with respect to the slotter shaft 105 and is supported so as to be rotated integrally in the circumferential direction (the rotational direction). The second slotter head 36A is movable in the axial direction (movable relative to) with respect to the slotter shaft 107 and is supported so as to be rotated integrally in the circumferential direction (the rotational direction). The third slotter head 37A is movable in the axial direction (movable relative to) with respect to the slotter shaft 109 and is supported so as to be rotated integrally in the circumferential direction (the rotational direction). In this case, for example, each of the slotter heads 35A, 36A, and 37A and each of the slotter shafts 105, 107, and 109 are connected to each other by a key or a spline.

In the pair of first frames 201 (refer to FIG. 2), several supporting shafts 211 are bridged and fixed to be respectively parallel to the slotter shafts 105, and a screw shaft 212 is bridged and rotatably supported to be parallel to the slotter shaft 105 between the several supporting shafts 211. Each supporting shaft 211 penetrates a movement frame (movement adjusting member) 213 and is supported to be movable to relative to the movement frame 213, and the screw shaft 212 penetrates the movement frame 213 to be screwed to the movement frame 213 and is supported to be rotatable relative to the movement frame 213. Meanwhile, the slotter knife 112A is mounted on the outer peripheral portion of the first slotter head 35A so as to be adjustable in position in the circumferential direction and the slotter knife 113A is fixed to the outer peripheral portion of the first slotter head 35A. In addition, in the first slotter head 35A, a circumferential groove 214 is formed at a position offset in the axial direction from each of the slotter knives 112A and 113A. In addition, in the movement frame 213, a recessed portion 213a is formed along the outer peripheral portion of the first slotter head 35A, an engagement piece (connection member) 215 is hung from the recessed portion 213a, and a tip portion of the engagement piece 215 engages with the circumferential groove 214 of the first slotter head 35A. The engagement piece 215 can be attached to or detached from the circumferential groove 214 by a device (not shown).

Accordingly, if the screw shaft 212 is rotated in a state where the engagement piece 215 engages with the circumferential groove 214, the movement frame 213 is moved in the axial direction of each supporting shaft 211. Therefore, the first slotter head 35A connected to the movement frame 213 via the engagement piece 215 is moved in the axial direction with respect to the slotter shaft 105.

Moreover, although not described, each of the slotter head 35A and the slotter head 35B positioned on the most left-side in the rotational axis direction in FIG. 3 has the same configuration. In addition, the lower blade 40 disposed to face each of the slotter heads 35A and 35B has the same configuration. In addition, similarly to the first slotter heads 35A and 35B, each of the first creasing line rolls 32, the second creasing line rolls 33, and the receiving rolls 38 and 39 supported by the first frames 201 has the same configuration.

In addition, as shown in FIGS. 5 and 6, in the pair of second frames 202 (refer to FIG. 2), several supporting shafts 221 are bridged and fixed to be respectively parallel to the slotter shafts 107 and 109, and a screw shaft 222 is bridged and rotatably supported to be parallel to the slotter shafts 107 and 109 between the several supporting shafts 221. Each supporting shaft 221 penetrates a movement frame (movement adjusting member) 223 and is supported to be movable to relative to the movement frame 223, and the screw shaft 222 penetrates the movement frame 223 to be screwed to the movement frame 223 and is supported to be rotatable relative to the movement frame 223.

Meanwhile, the slotter knife 115A is fixed to the outer peripheral portion of the second slotter head 36A and the slotter knife 116A is mounted on the outer peripheral portion of the second slotter head 36A so as to be adjustable in position in the circumferential direction.

In addition, in the second slotter head 36A, a circumferential groove 224 is formed at a position offset in the axial direction from each of the slotter knives 115A and 116A. Moreover, in the movement frame 223, a recessed portion 223a is formed along the outer peripheral portion of the second slotter head 36A, an engagement piece (connection member) 225 is hung from the recessed portion 223a, and a tip portion of the engagement piece 225 engages with the circumferential groove 224 of the second slotter head 36A.

In addition, the slotter knife 118A is mounted on the outer peripheral portion of the third slotter head 37A so as to be adjustable in position in the circumferential direction and the slotter knife 119A is fixed to the outer peripheral portion of the third slotter head 37A. In addition, in the third slotter head 37A, a circumferential groove 226 is formed at a position offset in the axial direction from each of the slotter knives 118A and 119A. Moreover, in the movement frame 223, a recessed portion 223b is formed along the outer peripheral portion of the third slotter head 37A, an engagement piece (connection member) 227 is hung from the recessed portion 223b, and a tip portion of the engagement piece 227 engages with the circumferential groove 226 of the third slotter head 37A.

Accordingly, if the screw shaft 222 is rotated in a state where the engagement pieces 225 and 227 respectively engage with the circumferential grooves 224 and 226, the movement frame 223 is moved in the axial direction of each supporting shaft 221. Therefore, the second slotter heads 36A and the third slotter head 37A connected to the movement frame 223 via the engagement pieces 225 and 227 are moved in the axial direction with respect to the slotter shafts 107 and 109.

Moreover, the movement frame 223 is moved, and thus, the second slotter heads 36A and the third slotter heads 37A are configured to be integrally moved in the axial direction with respect to the slotter shafts 107 and 109. However, the present invention is not limited to this. For example, the second slotter heads 36A and the third slotter heads 37A may be configured to be separately supported by the movement frame such that the second slotter heads 36A and the third slotter heads 37A are separately moved.

In addition, although not described, in FIG. 3, each of the slotter head 36A, the slotter head 36B, the slotter head 37A, and the slotter head 37B which are positioned at the most left-side in the rotational axis direction has the same configuration. In addition, each of the lower blades 41 and 42 disposed to face the slotter heads 36A, 36B, 37A, and 37B has the same configuration.

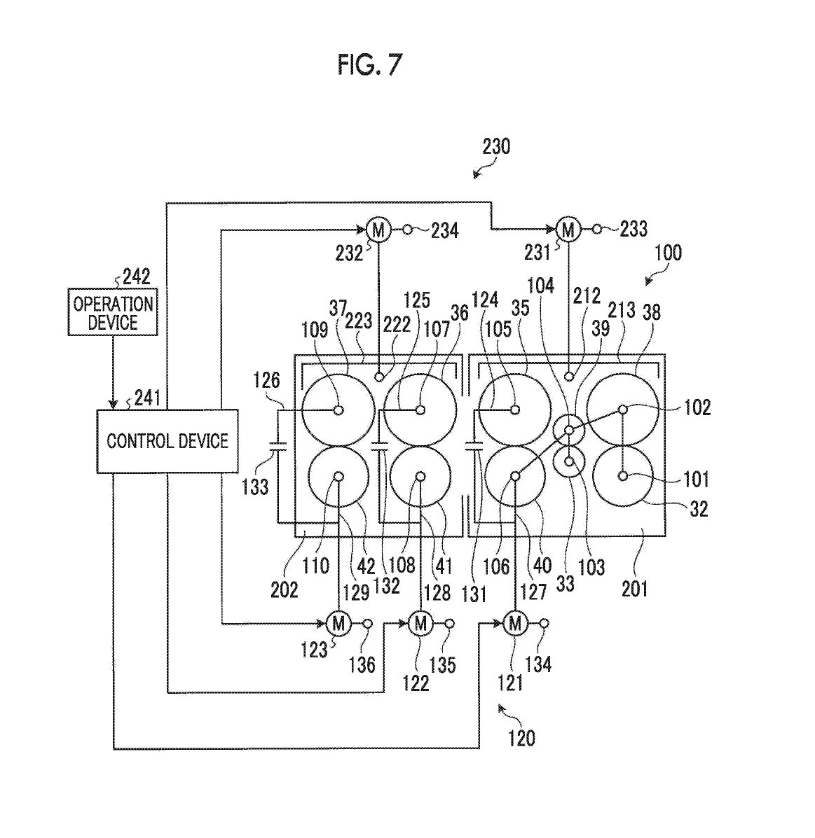

FIG. 7 is a schematic configuration view showing a driving system in the slotter apparatus.

The slotter apparatus 100 includes a drive device 120 which rotationally drives the slotter heads 35, 36 and 37 and the lower blades 40, 41, and 42, and a movement device 230 which moves the slotter heads 35, 36, and 37, the lower blades 40, 41, and 42, and the slotter shafts 105, 106, 107, 108, 109, and 110 in the axial direction.

The drive device 120 and the movement device 230 are connected to a control device 241 and an operation device 242 is connected to the control device 241.

That is, the roll shafts 101, 102, 103, and 104 and the slotter shafts 105 and 106 are drivingly connected to the first drive unit 121, and the creasing line rolls 32 and 33, the receiving rolls 38 and 39, and the first slotter heads 35 and the lower blades 40 can be drivingly rotated in synchronization with each other by the first drive unit 121. In this case, the first drive unit 121, the roll shafts 101, 102, 103, and 104, and the slotter shafts 105 and 106 are drivingly connected to each other by gears (not shown). The slotter shafts 107 and 108 are drivingly connected to a second drive unit 122, and the second slotter head 36 and the lower blade 41 can be drivingly rotated by the second drive unit 122. The slotter shafts 109 and 110 are drivingly connected to a third drive unit 123, and the third slotter head 37 and the lower blade 42 can be drivingly rotated by the third drive unit 123.

The drive device 120 includes the drive units 121, 122, and 123, and includes first drive transmission systems 124, 125, and 126 which drivingly rotate the slotter heads 35, 36, and 37, second drive transmission systems 127, 128, and 129 which drivingly rotate the lower blades 40, 41, and 42, and clutches 131, 132, and 132 (driving force disconnection units) which are provided in the first drive transmission systems 124, 125, and 126. Accordingly, in the drive device 120, by setting each of the clutches 131, 132, 133 to a connection state, each of the slotter heads 35, 36, 37 and each of the lower blades 40, 41, 42 can be drivingly rotated in synchronization with each other, and by setting each of the clutches 132 and 133 to a disconnection state, the slotter head 35, 36, and 37 are stopped and only the lower blades 40, 41, 42 can be drivingly rotated. In addition, by separately driving the drive unit 121, 122, and 123, the slotter heads 35 and the lower blades 40, the slotter heads 36 and the lower blades 41, and the slotter heads 37 and the lower blades 42 can be drivingly rotated or stopped individually.

Moreover, encoders 134, 135, and 136 are respectively connected to the drive units 121, 122, 123, and thus, by detecting a rotation speed and a rotational phase (rotation angle) of each of the drive units 121, 122, and 123, it is possible to detect a circumferential position of each of the slotter knives 112, 113, 115, 116, 118, and 119 of the slotter heads 35, 36, and 37.

Meanwhile, a fourth drive unit 231 is drivingly connected to the screw shaft 212, and the creasing line rolls 32 and 33, the receiving rolls 38 and 39, the first slotter heads 35, and the lower blades 40 can be moved in the axial direction via the movement frame 213 by the fourth drive unit 231. A fifth drive unit 232 is drivingly connected to the screw shaft 222, and the slotter heads 36 and 37 and the lower blades 41 and 42 can be moved in the axial direction via the movement frame 223 by the fifth drive unit 232.

The movement device 230 includes the drive units 231 and 232 and includes the above-described supporting shafts 211 and 221, screw shafts 212 and 222, movement frames 213 and 223, circumferential grooves 214, 224, and 226, engagement pieces 215, 225, and 227, or the like. In addition, encoders 233 and 234 are respectively connected to the drive units 231 and 232, and by detecting a rotation speed or a rotational phase (rotation angle) of each of the drive units 231 and 232, it is possible to detect an axial position of each of the slotter heads 35, 36, and 37 (each of the slotter knives 112, 113, 115, 116, 118, and 119).

A motor driver (not shown) is connected to each of the drive units 121, 122, 123, 231, and 232, and the motor driver is connected to the control device 241. In addition, in the carton-forming machine 10, a position sensor for detecting the position of the corrugated fiberboard S is provided in the sheet feeding section 11, and the control device 241 controls the drive units 121, 122, 123, 231, and 232 based on a detection result of the position sensor.

Meanwhile, periodical maintenance is performed on the carton-forming machine 10, or when troubles or failures occur in the carton-forming machine 10, maintenance is performed on the carton-forming machine 10.

In the slotter apparatus 100 of the slotter creaser section 31, since the several creasing line rolls 32 and 33, the several receiving rolls 38 and 39, the several slotter heads 35, 36, and 37, the several lower blades 40, 41, and 42, or the like are disposed to be close to each other, it is difficult for an operator to enter the inside of the slotter apparatus 100 so as to perform a maintenance work. For this reason, members in an area where the maintenance work is to be performed are moved to a retreat position (work position) by the movement device 230 so as to secure a work space, and the operator performs the maintenance work in the work space.

In this case, for example, during the maintenance work, the slotter heads 36A and 37A are moved to the retract positions in the axial directions of the slotter shafts 107 and 109, and thus, the work space is secured. After the maintenance work is performed, it is necessary to move each of the slotter heads 36A and 37A positioned at the retract position along the axial direction of each of the slotter shafts 107 and 109 and return to the original position. In this case, if positional accuracy at the original position to which each of the slotter head 36A and 37A is returned deteriorates, it will hinder processing accuracy of the corrugated fiberboard S to be performed after the deterioration of the positional accuracy. For example, in a case where one slicing is performed by the third slotter knives 115A of the second slotter heads 36A and the fifth slotter knives 118A of the third slotter heads 37A, if each of the third slotter knives 115A and each of the fifth slotter knives 118A are misaligned in the axial direction, a step is generated in the groove formed by each of the slotter knives 115A and 118A, and there is a concern that a defective product is generated.

In the slotter apparatus 100 of the first embodiment, when the several slotter heads positioned at the retract positions are moved along the axial direction so as to be returned to the original positions, it is possible to accurately position each slotter head at the original position. That is, as shown in FIG. 7, the control device 241 controls the movement device 230 when an adjustment mode in which several slotter heads 35, 36, and 37 (slotter knives 112, 113, 115, 116, 118, and 119) are positioned at predetermined positions set in advance (original positions) is selected. The adjustment mode is an axial adjustment mode in which the several slotter heads 35, 36, and 37 are moved to the same position as each other in the rotational axis direction by the movement device 230.

A slotter positioning method of the first embodiment includes a step of moving each of the several slotter heads 35, 36, and 37 positioned at the retract positions to a target position in the rotational axis direction based on target position data to be moved to a target position, a step of determining whether or not a positional deviation of each of the several slotter heads 35, 36, and 37 returned to the target position in the rotational axis direction is within a predetermined range set in advance, and a step of, based on a current position data of the slotter head 35 positioned on the most upstream side in the sheet transport direction D when the positional deviation is not within the predetermined range, moving other slotter heads 36 and 37 in the rotational axis direction.

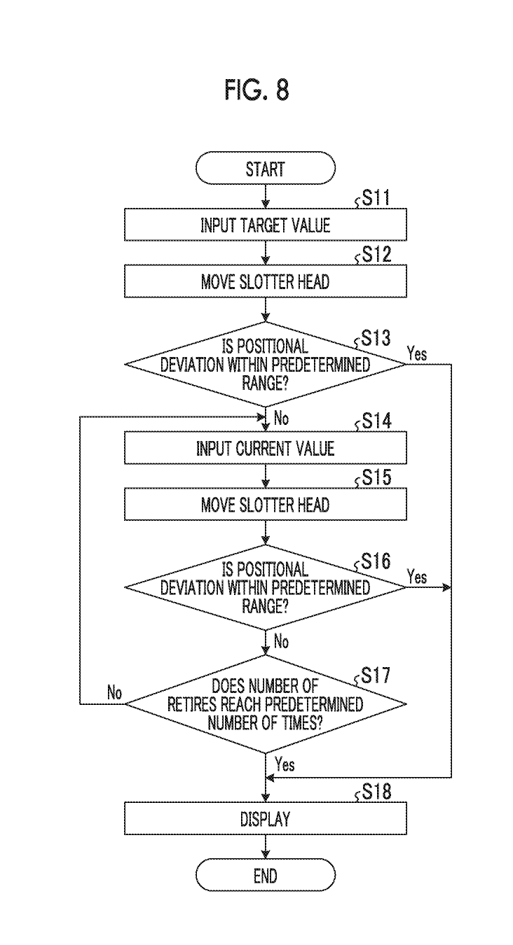

Hereinafter, the slotter positioning method will be described in detail. FIG. 8 is a flowchart showing the slotter positioning method. Moreover, in the following descriptions, a case where the first slotter heads 35A, the second slotter heads 36A, and the third slotter heads 36A are returned from the work positions to the original positions so as to be positioned in FIGS. 5 to 7 will be described.

When the first slotter heads 35A, the second slotter heads 36A, and the third slotter heads 37A are positioned at the retract positions offset from the original positions in the axial direction, as shown in FIG. 8, in Step S11, the operator inputs target values (target position data) at which the first slotter heads 35A, the second slotter heads 35A, and the third slotter heads 36A are positioned at the original positions to the control device 241 using the operation device 242. In Step S12, if the operator turns on an original position return switch in the axial adjustment mode using the operation device 242, the control device 241 drives the movement device 230 and moves each of the slotter heads 35A, 36A, and 37A positioned at the retract positions in the axial direction based on the target value so as to stop each slotter head at the original position which is the target position.

In Step S13, the control device 241 compares the current position of each of the stopped slotter heads 35A, 36A, and 37A based on the detection result input from the encoders 233 and 234 and the target position and calculates the positional deviation in the axial direction. In addition, the control device 241 determines whether or not the positional deviation is within the predetermined range. Here, if it is determined that the positional deviation is within the predetermined range (Yes), the step proceeds to Step S18, and an original position return operation end is displayed.

Meanwhile, it is determined that the positional deviation is not within the predetermined range (No), in Step S14, the current value (current position data) of the first slotter head 35A, which is disposed on the most upstream side in the sheet transport direction in the slotter heads 35A, 36A, and 37A returned to the original positions, is input as the target values of the second slotter head 36A and the third slotter head 37A except for the first slotter head 35A. In addition, in Step S15, the control device 241 drives the movement device 230 to move the second slotter head 36A and the third slotter head 37A in the axial direction based on the target value (the current value of the first slotter head 35A) and stops the second slotter head 36A and the third slotter head 37A at the original positions.

In Step S16, the control device 241 compares the current position of each of the stopped second slotter heads 36A and third slotter head 37A based on the detection result input from the encoder 234 and the target position and calculates the positional deviation in the axial direction. In addition, the control device 241 determines whether or not the positional deviation is within the predetermined range. Here, if it is determined that the positional deviation is within the predetermined range (Yes), the step proceeds to Step S18, and the original position return operation end is displayed.

Meanwhile, it is determined that the positional deviation is not within the predetermined range (No), in Step S17, it is determined whether or not the number of retries of each of the second slotter heads 36A and the third slotter heads 37A reaches a predetermined number of times (for example, two times). Here, it is determined that the number of retries does not reach the predetermined number of times (No), the step returns to Step S14 and the processing is performed. Meanwhile, it is determined that the number of retries reaches the predetermined number of times (Yes), the step proceeds to Step S18, and the original position return operation end is displayed.

If the return positioning processing of each of the slotter heads 35A, 36A, 37A to the original position is completed, the control device 241 drives the slotter apparatus 100 using the drive device 120 and trially slices the corrugated fiberboard S. The operator checks whether or not the shape, the dimensions, or the like of the groove of the processed corrugated fiberboard S are appropriate.

Here, slicing with respect to the corrugated fiberboard S performed by the slotter apparatus 100 of the first embodiment will be described. In addition, in descriptions below, a portion of the corrugated fiberboard S is shown and described.

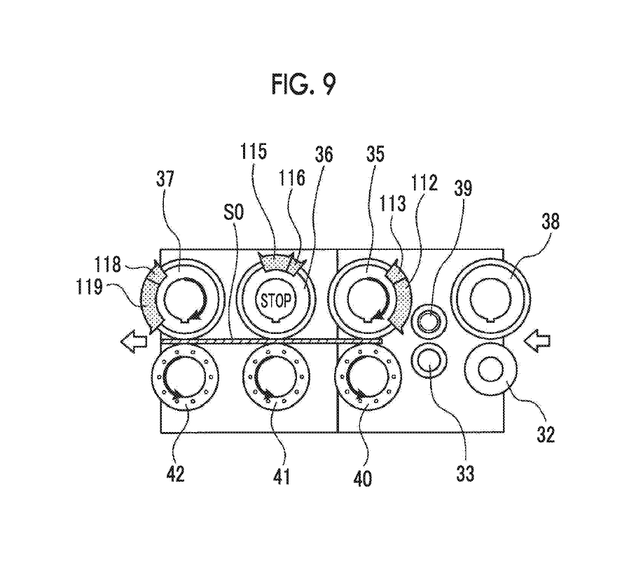

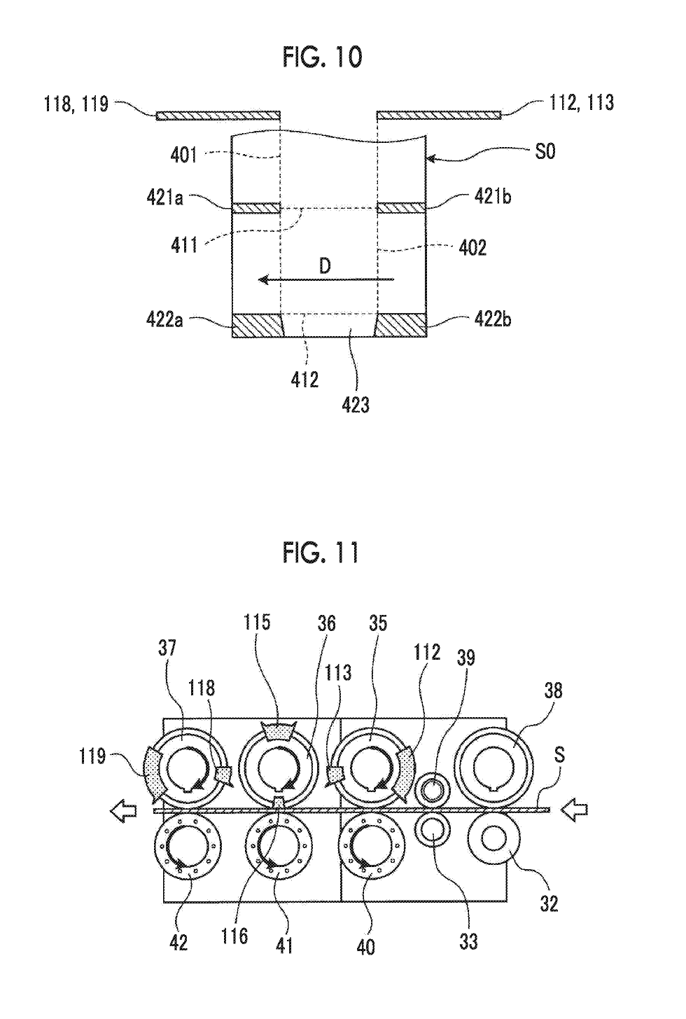

First, slicing of a single box sheet performed by the slotter apparatus 100 will be described. FIG. 9 is a schematic view of the slotter apparatus showing an arrangement of slotter knives when the single box sheet is processed and FIG. 10 is a plan view showing the single box sheet.

As shown in FIG. 9, in a case where slicing is performed on a single box sheet (corrugated fiberboard) S0, the position is adjusted such that the first slotter knife 112 comes into contact with the fixed second slotter knife 113 in the first slotter head 35, the position is adjusted such that the fourth slotter knife 116 comes into contact with the fixed third slotter knife 115 in the second slotter head 36, and the position is adjusted such that the fifth slotter knife 118 comes into contact with the fixed sixth slotter knife 119 in the third slotter head 37. In addition, the drive of the second slotter head 36 is stopped while the first slotter head 35 and the third slotter head 37 is drivingly rotated.

As shown in FIGS. 9 and 10, folding lines 401 and 402 are formed on the corrugated fiberboard (single box sheet) S0 in the pre-process. First, when the corrugated fiberboard S0 passes through the first creasing line rolls 32, creasing lines 411 and 412 are formed, and when corrugate fiberboard S0 passes through the second creasing line rolls 33, the creasing lines 411 and 412 are formed again. Next, when the corrugated fiberboard S0 passes through the first slotter head 35A, a groove 421b is formed at the position of the creasing line 411 by the first slotter knife 112A (second slotter knife 113A). In addition, when the corrugated fiberboard S0 passes through the first slotter head 35B, an end portion 422b is cut at the position of the creasing line 412 by the first slotter knife 112B (second slotter knife 113B). Moreover, when the corrugated fiberboard S0 passes through the third slotter head 37A after passing through the stopped second slotter head 36, a groove 421a is formed at the position of the creasing line 411 by the sixth slotter knife 119A (fifth slotter knife 118A). In addition, when the corrugated fiberboard S0 passes through the third slotter head 37B, an end portion 422a is cut at the position of the creasing line 412 by the sixth slotter knife 119B (fifth slotter knife 118B), and a gluing margin strip 423 is formed. Moreover, when the corrugated fiberboard S0 passes through the slitter head 34 (refer to FIG. 3), the end portion is cut at the cut position.

In the case where the slicing is performed on the corrugated fiberboard S0 of the single box sheet, skip feed processing can be performed. This skip feed processing is applied to slicing with respect to a corrugated fiberboard S0 having a relatively larger size in the transport direction than a general corrugated fiberboard. That is, as shown in FIG. 1, in the sheet feeding section 11, when the corrugated fiberboard S stacked on the table 12 is fed, the corrugated fiberboard S is fed every other time with respect to the feeding timing of a general corrugated fiberboard S. In general, in the printing section 21, the sheet feeding section 11 feeds one corrugated fiberboard S with respect to one rotation of the printing cylinder 22. However, in the skip feed processing, in the printing section 21, the sheet feeding section 11 feeds one corrugated fiberboard S with respect to two rotations of the printing cylinder 22. As a result, even when the corrugated fiberboard S having a long size in the transport direction is provided, the corrugated fiberboard S can be appropriately transported while the end portions of the front and rear corrugated fiberboards S do not come into contact with each other.

When the skip feed processing is performed on the corrugated fiberboard S0 of the single box sheet, as shown in FIGS. 9 and 10, the drive of the second slotter head 36 is stopped while the first slotter head 35 and the third slotter head 37 are drivingly rotated, grooves 421a and 421b can be formed at the position of the creasing line 411 by the first slotter knife 112, the second slotter knife 113, the fifth slotter knife 118, and the sixth slotter knife 119, and the end portions 422a and 422b are cut at the position of the creasing line 412 to form the gluing margin strip 423.

Next, slicing with respect to the twin box sheet performed by the slotter apparatus 100 will be described.

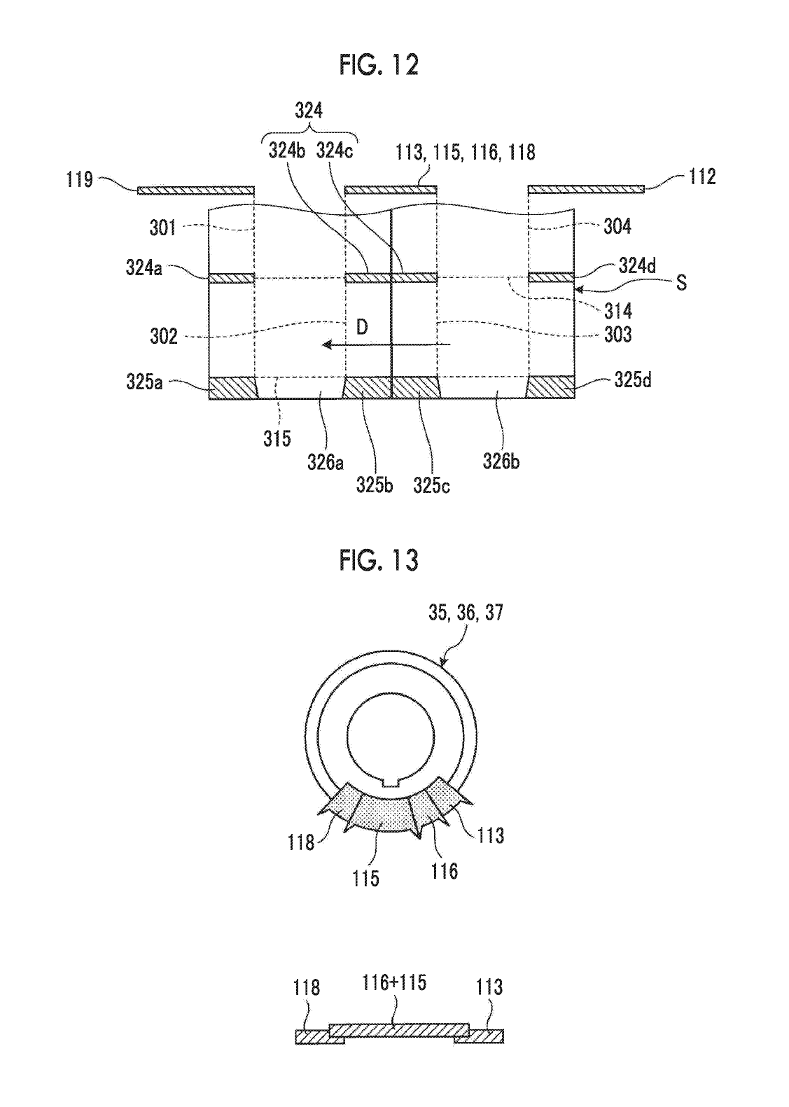

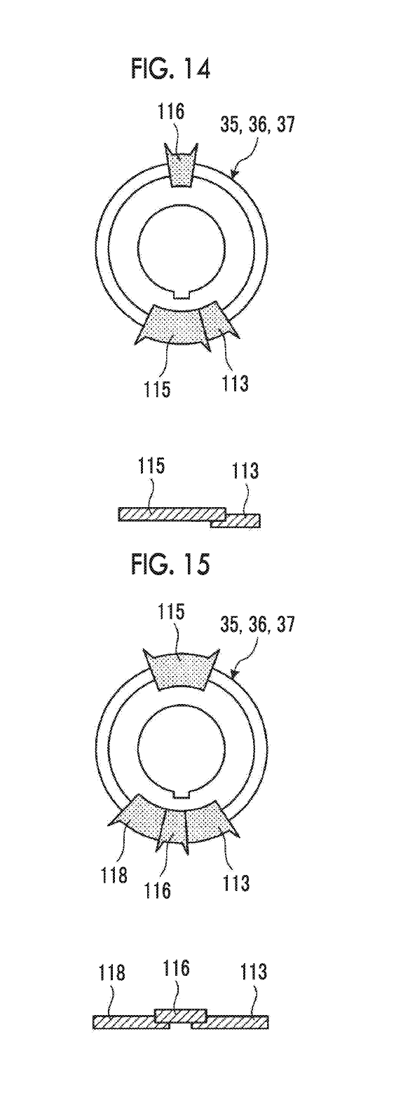

FIG. 11 is a schematic view of the slotter apparatus showing an arrangement of slotter knives when the twin box sheet is processed, FIG. 12 is a plan view showing the twin box sheet, FIG. 13 is a schematic view for explaining phases of several slotter knives so as to process the communication groove, FIG. 14 is a schematic view for explaining phases of several slotter knives so as to process another communication groove, and FIG. 15 is a schematic view for explaining phases of several slotter knives so as to process still another communication groove.

As shown in FIG. 11, in a case where slicing is performed on the twin box sheet (corrugated fiberboard) S having a relatively long length (groove length) in the transport direction, the first slotter knife 112 is adjusted to be positioned at a predetermined position with respect to the fixed second slotter knife 113 in the first slotter head 35, the fourth slotter knife 116 is adjusted to be positioned at a predetermined position with respect to the fixed third slotter knife 115 in the second slotter head 36, and the fifth slotter knife 118 is adjusted to be positioned at a predetermined position with respect to the fixed sixth slotter knife 119 in the third slotter head 37. The first slotter head 35, the second slotter head 36, and the third slotter head 37 are drivingly rotated.

As shown in FIGS. 11 and 12, the folding lines 301, 302, 303, and 304 are formed on the corrugated fiberboard (twin box sheet) S in the pre-process. First, the creasing lines 314 and 315 are formed when the corrugated fiberboard S passes through the first creasing line rolls 32, and the creasing lines 314 and 315 are formed again when the corrugated fiberboard S passes through the second creasing line rolls 33. Next, when the corrugated fiberboard S passes through the first slotter head 35A, the groove 324d is formed at the position of the creasing line 314 by the first slotter knife 112A and a portion of the groove 324c is formed at the position of the creasing line 314 by the second slotter knife 113A. Moreover, when the corrugated fiberboard S passes through the first slotter head 35B, the end portion 325d is cut at the position of the creasing line 315 by the first slotter knife 112B and a portion of the end portion 325c is cut by the second slotter knife 113B to form the gluing margin strip 326b.

Continuously, when the corrugated fiberboard S passes through the second slotter head 36A, a portion of each of the grooves 324b and 324c is formed at the position of the creasing line 314 by the third slotter knife 115A and the fourth slotter knife 116A. In addition, when the corrugated fiberboard S passes through the second slotter head 36B, a portion of each of the end portions 325b and 325c is formed at the position of the creasing line 315 by the third slotter knife 115B and the fourth slotter knife 116B. Finally, when the corrugated fiberboard S passes through the third slotter head 37A, the grooves 324b and 324c are completely formed at the position of the creasing line 314 by the fifth slotter knife 118A and the groove 324a is formed at the position of the creasing line 314 by the sixth slotter knife 119B. Moreover, when the corrugated fiberboard S passes through the third slotter head 37B, the end portions 325b and 325c are completely cut at the position of the creasing line 315 by the fifth slotter knife 118B and the end portion 325a is cut by the sixth slotter knife 119B to form the gluing margin strip 326a. In addition, when the corrugated fiberboard S passes through the slitter head 34 (refer to FIG. 3), the end portion is cut at the cut position.

That is, as shown in FIG. 13, since rotation phases of the four slotter knives 113, 115, 116, and 118 are continued so as to partially overlap each other with respect to the corrugated fiberboard S at the positions of the slotter heads 35, 36, and 37, by cutting the grooves 324b and 324c stepwise, finally, it is possible to form the communication groove 324, and it is possible to cut the end portions 325b and 325c stepwise. In addition, in the above-descriptions, since the corrugated fiberboard S passes through the first slotter head 35, the second slotter head 36, and the third slotter head 37 in this order, the processing positions are described in order of the slotter head 35, 36, and 37. However, in actual, the slotter heads 35, 36, and 37 approximately simultaneously performs cutting on the corrugated fiberboard S.

In addition, in a case where the grooves 324a, 324b, 324c, and 324d are formed on the corrugated fiberboard S to cut the end portions 325a, 325b, 325c, and 325d, combinations of the slotter knives which form the grooves 324b and 324c to cut the end portions 325b and 325c are not limited to the above-described combinations. For example, in a case where slicing is performed on the twin box sheet (corrugated fiberboard) S having a relatively short length (groove length) in the transport direction, as shown in FIG. 14, the grooves 324b and 324c are formed on the corrugated fiberboard S and the end portions 325b and 325c are cut using the second slotter knife 113 and the third slotter knife 115. That is, since the rotation phases of the two slotter knives 113 and 115 is continued so as to partially overlap each other with respect to the corrugated fiberboard S at the positions of the slotter heads 35, 36, and 37, by cutting the grooves 324b and 324c stepwise, finally, it is possible to form the communication groove 324, and it is possible to cut the end portions 325b and 325c stepwise.

Moreover, in a case where slicing is performed on the twin box sheet (corrugated fiberboard) S, as shown in FIG. 15, the grooves 324b and 324c are formed on the corrugated fiberboard S and the end portions 325b and 325c are cut using the second slotter knife 113, the fourth slotter knife 116, and the fifth slotter knife 118. That is, since the rotation phases of the three slotter knives 113, 116, 118 is continued so as to partially overlap each other with respect to the corrugated fiberboard S at the positions of the slotter heads 35, 36, and 37, by cutting the grooves 324b and 324c stepwise, finally, it is possible to form the communication groove 324, and it is possible to cut the end portions 325b and 325c stepwise.

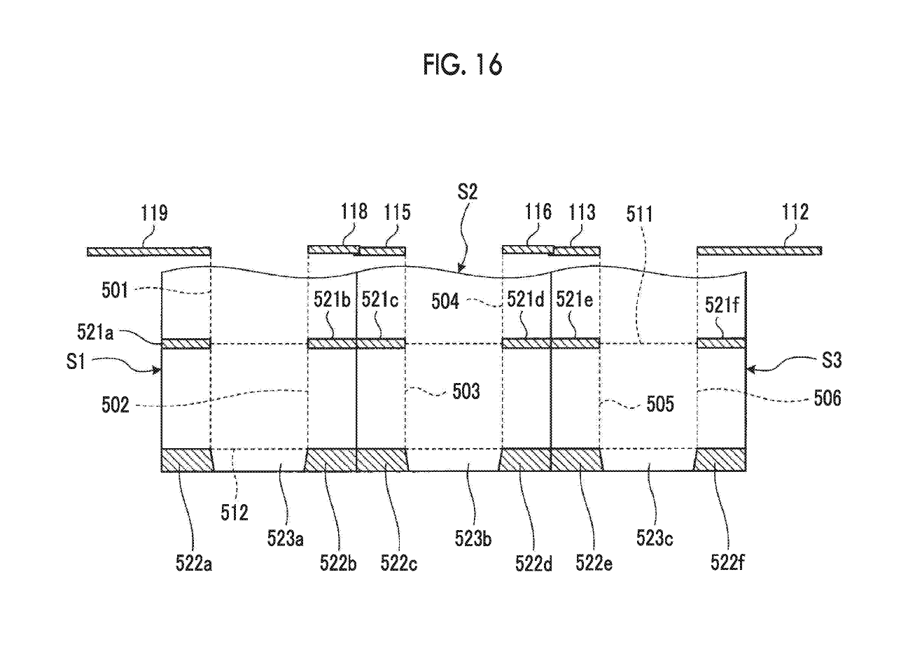

Finally, slicing with respect to a triple box sheet performed by the slotter apparatus 100 will be described. FIG. 16 is a schematic view of the slotter device showing an arrangement of slotter knives when the triple box sheet is processed.

As shown in FIG. 11, similarly to the twin box sheet, in a case where slicing is performed on the triple box sheet (corrugated fiberboard) S, the slotter knives 112, 116, and 118 are adjusted to be positioned at predetermined positions with respect to the fixed slotter knives 113, 115, and 119 in the slotter heads 35, 36, and 37.

In addition, the first slotter head 35, the second slotter head 36, and the third slotter head 37 are drivingly rotated.

As shown in FIGS. 11 and 16, folding lines 501, 502, 503, 504, 505, and 506 are formed on the corrugated fiberboard (triple box sheet) S (S1, S2, and S3) in the pre-process. First, the creasing lines 511 and 512 are formed when the corrugated fiberboard S passes through the first creasing line roll 32, and the creasing lines 511 and 512 are formed again when the corrugated fiberboard S passes through the second creasing line roll 33. Next, when the corrugated fiberboard S passes through the first slotter head 35A, the groove 521f is formed at the position of the creasing line 511 by the first slotter knife 112A and a portion of each of the grooves 521d and 521e is formed at the position of the creasing line 511 by the second slotter knife 113A. Moreover, when the corrugated fiberboard S passes through the first slotter head 35B, an end portion 522f is cut at the position of the creasing line 512 by the first slotter knife 112B and a portion of each of end portions 522d and 522e is cut by the second slotter knife 113B to form a gluing margin strip 523c.

Continuously, when the corrugated fiberboard S passes through the second slotter head 36A, the grooves 521d and 521e are completely formed at the position of the creasing line 511 by the fourth slotter knife 116A and a portion of each of the grooves 521b and 521c is formed at the position of the creasing line 511 by the third slotter knife 115A. In addition, when the corrugated fiberboard S passes through the second slotter head 36B, the end portions 522d and 522e are completely cut at the position of the creasing line 512 by the fourth slotter knife 116B and a portion of each of the end portions 522b and 522c is cut by the third slotter knife 115B to form a gluing margin strip 523b. Finally, when the corrugated fiberboard S passes through the third slotter head 37A, the grooves 521b and 521c are completely formed at the position of the creasing line 511 by the fifth slotter knife 118A and a groove 521a is formed at the position of the creasing line 511 by the sixth slotter knife 119A. Moreover, when the corrugated fiberboard S passes through the third slotter head 37B, the end portions 522b and 522c are completely cut at the position of the creasing line 512 by the fifth slotter knife 118B and the end portion 522a is cut by the sixth slotter knife 119B to form a gluing margin strip 523a. When the corrugated fiberboard S passes through the slitter head 34 (refer to FIG. 3), the end portion is cut at the cut position.

In this way, the slotter apparatus of the first embodiment includes the several slotter heads 35, 36, and 37 which include slotter knives 112, 113, 115, 116, 118, and 119 mounted on the slotter heads and are rotatably supported, the several lower blades 40, 41, and 42 which are rotatably supported and are disposed to face the several slotter heads 35, 36, and 37, the drive device 120 which drivingly rotates the slotter heads 35, 36, and 37 and the lower blades 40, 41, and 42, the movement device 230 which moves the slotter heads 35, 36, and 37 and the lower blades 40, 41, 42 in the rotational axis direction, and the control device 241 which controls the movement device 230 when an adjustment mode in which each of the slotter knives 112, 113, 115, 116, 118, and 119 is positioned at the predetermined position set in advance is selected.

Accordingly, if the axial adjustment mode is selected, the control device 241 moves the slotter heads 35, 36, and 37 having the slotter knives 112, 113, 115, 116, 118, and 119 in the rotation axial direction by the movement device 230, and positions each of the slotter heads 35, 36, and 37 at the predetermined position set in advance. Therefore, it is possible to position each of the slotter knives 112, 113, 115, 116, 118, and 119 at the desired position at an early stage, and it is possible to improve efficiency of a position adjustment work.

In the slotter apparatus of the first embodiment, the drive device 120 includes the first drive transmission systems 124, 125, and 126 which drivingly rotate the slotter heads 35, 36, and 37, the second drive transmission systems 127, 128, and 129 which drivingly rotate the lower blades 40, 41, and 42, and the clutches 131, 132, and 133 which are provided in the first drive transmission systems 124, 125, and 126. Accordingly, the drive device 120 can drivingly rotate the slotter heads 35, 36, and 37 by the first drive transmission systems 124, 125, and 126, can drivingly rotate the lower blades 40, 41, and 42 by the second drive transmission systems 127, 128, and 129, can stop only the driving rotations of the slotter heads 35, 36, and 37 by the clutches 131, 132, and 133, and can rotate the lower blades 40, 41, and 42 so as to transport the corrugated fiberboard S even when the rotations of the slotter heads 35, 36, and 37 are stopped.

In the slotter apparatus of the first embodiment, the drive device 120 includes the several drive units 121, 122, and 123 which drivingly rotates the slotter heads 35, 36, and 37 independently. Accordingly, it is possible to select the slotter heads 35, 36, and 37 used according to the type of the corrugated fiberboard S to be processed, and it is possible to improve versatility.

In the slotter apparatus of the first embodiment, the slotter heads 35, 36, and 37 are supported to be moved relative to each other in the rotational axis direction and to be integrally rotated in a circumferential direction, the lower blades 40, 41, 42 are supported to be moved relative to each other in the rotational axis direction and to be integrally rotated in the circumferential direction, the movement device 230 includes movement frames 213 and 223, each of which can be moved in the direction parallel to the axis direction of each of the slotter shafts 105, 106, 107, 108, 109, and 110, and the engagement pieces 215, 225, and 227 which can connect the movement frames 213 and 223, and the slotter heads 35, 36, and 37 and the lower blades 40, 41, and 42 to each other. Accordingly, the movement device 230 can easily move the slotter heads 35, 36, and 37 and the lower blades 40, 41, and 42 via the engagement pieces 215, 225, and 227 in the axial direction by the movement frames 213 and 223, and it is possible to improve workability when the positions of the slotter heads 35, 36, and 37 and the lower blades 40, 41, and 42 are adjusted.

In the slotter apparatus of the first embodiment, the adjustment mode is the axial adjustment mode in which the slotter heads 35, 36, and 37 are moved to the same position as each other in the rotational axis direction by the movement device 230. Accordingly, if the axial adjustment mode is selected, the control device 241 moves the slotter heads 35, 36, and 37 to the same position as each other in the rotational axis direction by the movement device 230, and thus, when the slotter heads 35, 36, and 37 are moved to the work positions, it is possible to return each of the slotter heads 35, 36, and 37 to the desired position at an early stage.

In the slotter apparatus of the first embodiment, in the axial adjustment mode, the control device 241 moves other slotter heads 36 and 37 to the movement position of the slotter head 35 disposed on the most upstream side in the sheet transport direction in the slotter heads 35, 36, and 37, by the movement device 230. Accordingly, it is possible to position the slotter heads 35, 36, and 37 according to the creasing line rolls 32 and 33, and it is possible to improve the processing accuracy of the corrugated fiberboard S.

In the slotter apparatus of the first embodiment, when each of the slotter heads 35, 36, and 37 is moved to the preset target position and the positional deviation in the rotational axis direction at each movement position of the slotter heads 35, 36, and 37 is not within the predetermined range set in advance, the control device 241 moves other heads 36 and 37 to a movement position of the slotter head 35 disposed on the most upstream side.

Accordingly, movement errors of the several slotter heads 35, 36, and 37 converge within the range of the movement error of one slotter head 35, and it is possible to improve the positioning accuracy of each of the slotter heads 35, 36, and 37.

In the slotter apparatus of the first embodiment, after the control device 241 positions each of the slotter heads 35, 36, and 37 having the slotter knives 112, 113, 115, 116, 118, and 119 at the predetermined position, the control device 120 drivingly rotates the slotter heads 35, 36, and 37 and the lower blades 40, 41, and 42 by the drive device and trially slices the corrugated fiberboard S. Accordingly, it is possible to check the positioning accuracy of each of the slotter knives 112, 113, 115, 116, 118, and 119.

In addition, Moreover, the slotter positioning method of the first embodiment includes a step of moving the slotter heads 35, 36, and 37, which are positioned at work positions, in the rotational axis direction based on the target position data so as to move each of the slotter heads 35, 36, and 37 to the target position, a step of determining whether or not the positional deviation in the rotational axis direction of each of the slotter heads 35, 36, and 37 moved to the target positions is within the predetermined range set in advance, and a step of moving, when the positional deviation is not within the predetermined range, other slotter heads 36 and 37 in the rotational axis direction based on the current position data of the slotter head 35 disposed on the most upstream side in the sheet transport direction.

Accordingly, when each of the several slotter heads 35, 36, and 37 positioned at the work positions are moved to the target position based on the target position data, if positional deviations occur in the several slotter heads 35, 36, and 37, other slotter heads 36 and 37 are moved to the current position of the slotter head 35 disposed on the most upstream side. Accordingly, the movement error of each of the slotter heads 35, 36, and 37 decreases, and thus, it is possible to accurately position each of the slotter knives 112, 113, 115, 116, 118, and 119 at the desired position, and it is possible to improve the efficiency of the position adjustment work of each of the slotter knives.

Moreover, the carton-forming machine of the first embodiment includes the sheet feeding section 11, the printing section 21, the slotter creaser section 31, the die-cut section 51, the cutting section 61, the speed-increasing section 71, the folding section 81, and the counter-ejector section 91, and the slotter apparatus 100 is provided in the slotter creaser section 31.

Accordingly, in the printing section 21, the printing is performed on the corrugated fiberboard S supplied from the sheet feeding section 11, and in the slotter creaser section 31, the creasing line processing and the slicing are performed on the corrugated fiberboard S. Moreover, in the folding section 81, the fiberboard S is folded, the end portions are joined to each other, and the corrugated box is formed. In addition, in the counter-ejector section 91, the corrugated boxes are stacked while being counted. In addition, beforehand, in the slotter apparatus 100, the slotter heads 35, 36, and 37 having the slotter knives 112, 113, 115, 116, 118, and 119 are moved in the rotational axis direction by the movement device 230 and are positioned at the predetermined positions set in advance. Therefore, it is possible to position each of the slotter knives 112, 113, 115, 116, 118, and 119 at the desired position at an early stage, and it is possible to improve the efficiency of the position adjustment work of the slotter.

### Second Embodiment

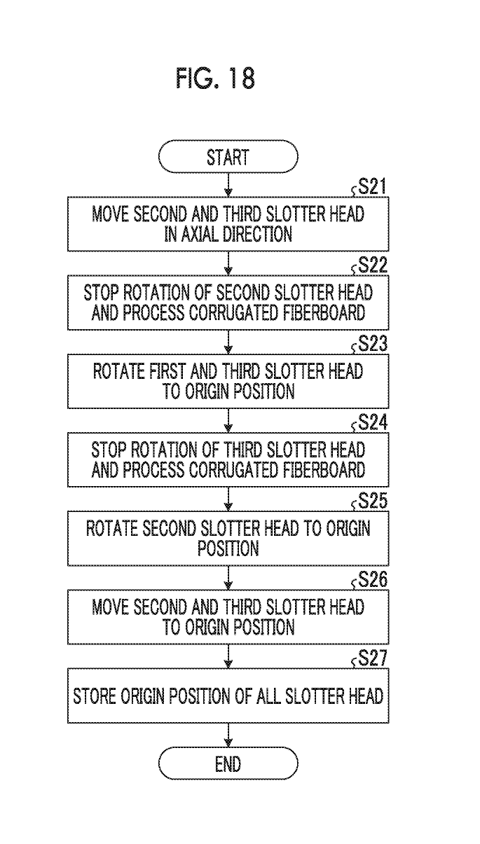

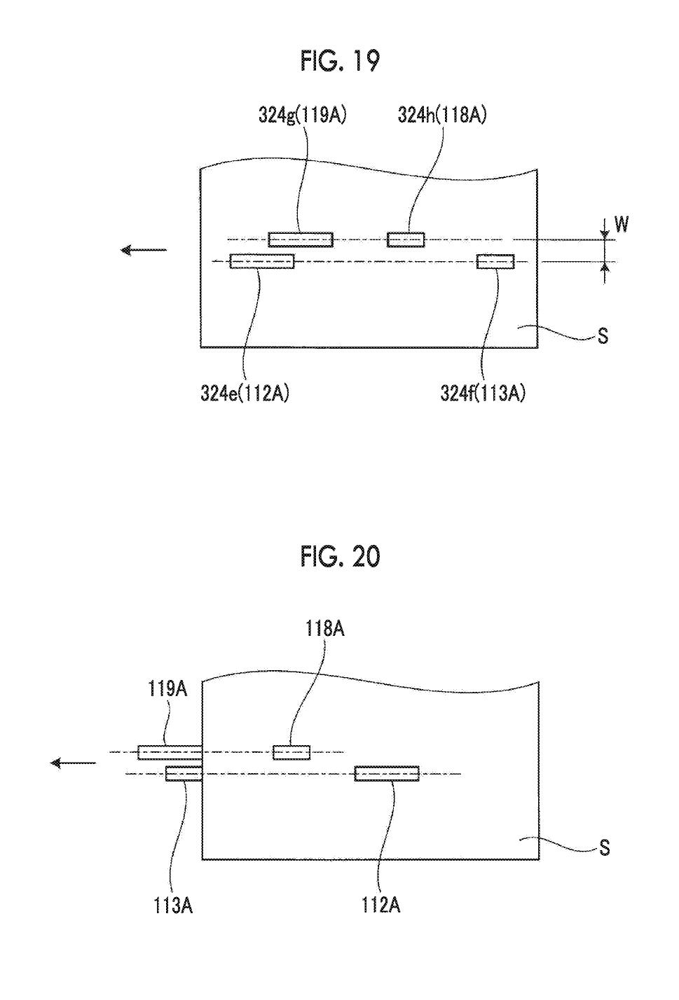

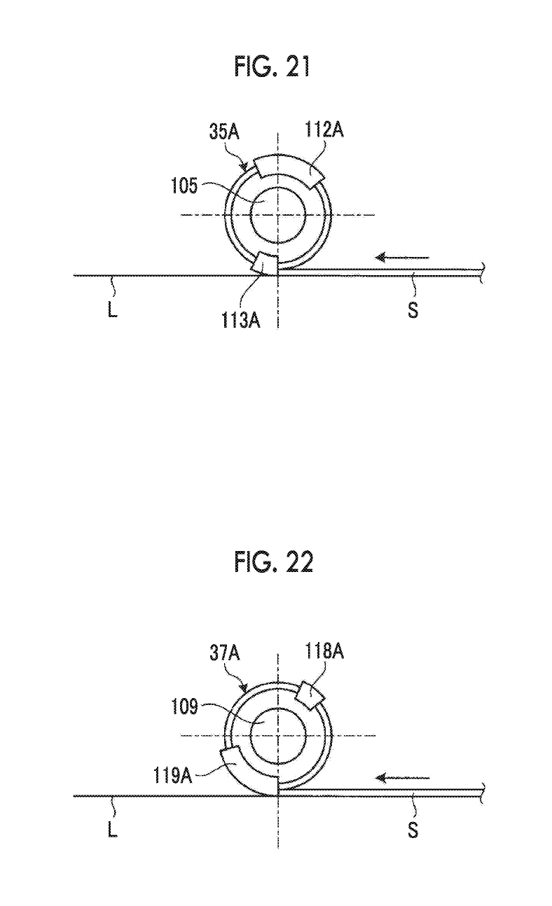

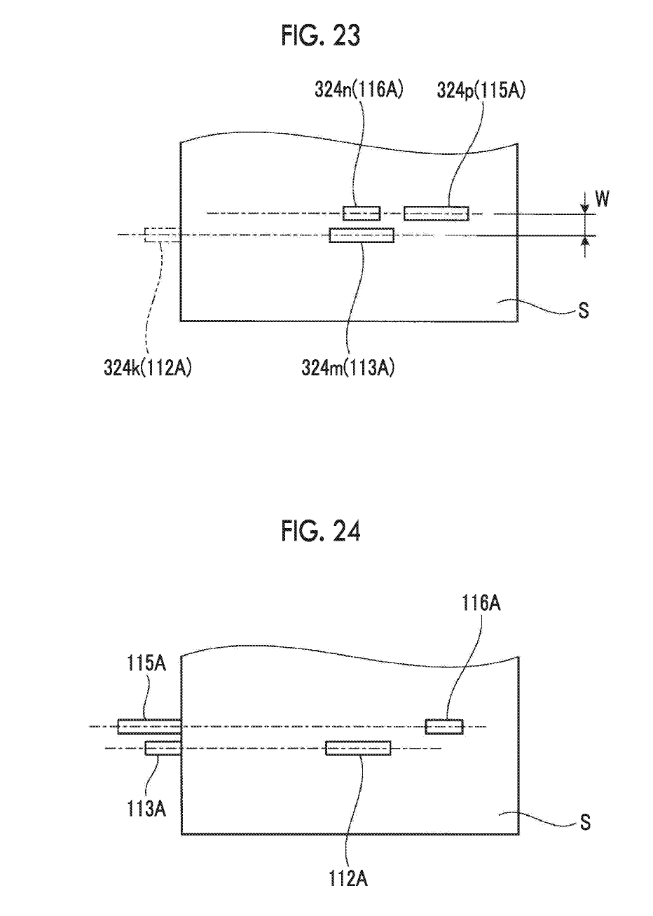

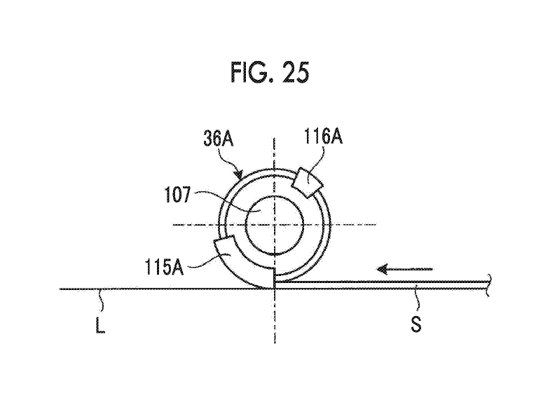

FIG. 18 is a flowchart showing a slotter positioning method in a slotter apparatus of a second embodiment, FIG. 19 is a plan view showing a corrugated fiberboard processed during indexing of the first and third slotter knives, FIG. 20 is a plan view showing the corrugated fiberboard processed after the indexing of first and third slotter knives, FIG. 21 is a schematic view showing the indexed first slotter knife, FIG. 22 is a schematic view showing the indexed third slotter knife, FIG. 23 is a plan view showing the corrugated fiberboard processed during indexing of the second slotter knife, FIG. 24 is a plan view showing the corrugated fiberboard processed after the indexing of the second slotter knife, and FIG. 25 is a schematic view showing the indexed second slotter knife.

In addition, a basic configuration of the slotter apparatus of the present embodiment is substantially similar to that of the above-described first embodiment, and thus, the slotter apparatus of the present embodiment is described with reference to FIGS. 2, 3, and 5 to 7, the same reference numerals are assigned to the members having functions similar to those of the first embodiment, and descriptions thereof are omitted.

As shown in FIGS. 2, 3, and 5 to 7, when the corrugated fiberboard S is processed, in the slotter apparatus 100, it is necessary to adjust the axial positions of the creasing line rolls 32 and 33, the receiving rolls 38 and 39, the slotter heads 35, 36, and 37, and the lower blades 40, 41, and 42 according to the size of the corrugated fiberboard S, and it is necessary to adjust the circumferential positions of the slotter knives 112, 113, 115, 116, 118, and 119 mounted on the slotter heads 35, 36, and 37.

Meanwhile, when the operation of the carton-forming machine 10 starts, in the slotter apparatus 100, it is unknown which the circumferential position of each of the slotter knives 112, 113, 115, 116, 118, and 119 is attached to each of the slotter heads 35, 36, and 37. In this case, the slicing is performed on the corrugated fiberboard S at the current circumferential position of each of the slotter knives 112, 113, 115, 116, 118, and 119, the groove shape (length or position) of the corrugated fiberboard S processed by the operator is confirmed, and thus, the circumferential position of each of the slotter knives 112, 113, 115, 116, 118, and 119 can be known. Meanwhile, for example, one groove may be processed by the two slotter knives 113 and 115. In this case, it is difficult to know the circumferential position of each of the slotter knives 113 and 115 from the groove shape of the processed corrugated fiberboard S.

In the slotter apparatus 100 of the second embodiment, the slotter knives whose circumferential positions are unknown are adjusted to predetermined processing positions, it is possible to position the slotter knives at the origin positions once. That is, as shown in FIG. 7, when the adjustment mode in which each of the several slotter heads 35, 36, and 37 (slotter knives 112, 113, 115, 116, 118, and 119) is positioned at the predetermined position set in advance (origin position) is selected, the control device 241 controls the drive device 120. The adjustment mode is a circumferential adjustment mode in which each of the several slotter heads 35, 36, and 37 is rotated to an origin position, at which an end portion of each of the slotter knives 113, 115, and 119 is positioned at a sheet transport line, by the drive device 120.

The slotter positioning method of the second embodiment includes a step of moving at least one slotter head 35, 36, or 37 of several slotter heads 35, 36, and 37 on which the slotter knives 112, 113, 115, 116, 118, and 119 are mounted to a work position offset in a rotational axis direction, a step of rotating the several slotter heads 35, 36, and 37 to slice the corrugated fiberboard S, a step of rotating, based on a sheet processed shape, at least the slotter heads 35, 36, and 37 positioned the work position to an origin position at which an end portion of each of the slotter knives 113, 115, and 119 is positioned at a sheet transport line, and a step of moving the slotter heads 35, 36, and 37 positioned at the work positions in the rotational axis direction so as to return the slotter heads 35, 36, and 37 to the original positions.

Hereinafter, the slotter positioning method will be described in detail. Moreover, in the following descriptions, a case where each of the slotter heads 35A, 36A, and 37A is positioned at the origin position in FIGS. 2, 3, and 7 will be described.

As shown in FIG. 18, in Step S21, the control device 241 moves the second slotter heads 36A and the third slotter heads 37A in the axial direction via the movement frames 223 by the movement device 230 and stops each of the slotter heads 36A and 37A at a position offset by a predetermined distance W. In Step S22, the control device 241 drivingly rotates the first slotter heads 35A and the third slotter heads 37A in a state where the driving rotations of the second slotter heads 36A performed by the drive device 120 are stopped so as to slice the corrugated fiberboard S. In addition, in Step S23, each of the first slotter heads 35A and the third slotter heads 37A is rotated to the origin position at which the end portion of each of the slotter knives 113A and 119A is positioned at the sheet transport line L.

That is, as shown in FIG. 19, when each of the second slotter heads 36A and the third slotter heads 37A is positioned at the position offset by the predetermined distance W from the original position, the second slotter heads 36A are stopped, and the first slotter heads 35A and the third slotter heads 37A are drivingly rotated.

Accordingly, the corrugated fiberboard S is sliced by the slotter knives 112A and 113A of the first slotter heads 35A and the slotter knives 118A and 119A of the third slotter heads 37A, and thus, grooves 324e and 324f are formed at the original positions and grooves 324g and 324h are formed at the offset positions. Therefore, the rotation positions of the slotter knives 112A and 113A in the first slotter heads 35A and the rotation positions of the slotter knives 118A and 119A in the third slotter heads 37A can be known. The operator drives the drive device 120 by the operation device 242, and as shown in FIGS. 20 and 21, the operator rotates each of the first slotter heads 35A to the origin position at which a circumferential end portion of each of the slotter knives 113A is positioned at the sheet transport line L, and as shown in FIGS. 20 and 22, the operator rotates each of the third slotter heads 37A to the origin position at which a circumferential end portion of each of the slotter knives 119A is positioned at the sheet transport line L.

Returning to FIG. 18, in Step S24, the control device 241 drivingly rotates the first slotter heads 35A and the second slotter heads 36A in a state where the driving rotations of the third slotter heads 37A performed by the drive device 120 are stopped so as to slice the corrugated fiberboard S. In addition, in Step S25, each of the second slotter heads 36A is rotated to the origin position at which the end portion of each of the slotter knives 115A and 116A is positioned at the sheet transport line L.

That is, as shown in FIG. 23, when each of the second slotter heads 36A and the third slotter heads 37A is positioned at the position offset by the predetermined distance W from the original position, the third slotter heads 37A are stopped, and the first slotter heads 35A and the second slotter heads 36A are drivingly rotated.

Accordingly, the corrugated fiberboard S is sliced by the slotter knives 112A and 113A of the first slotter heads 35A and the slotter knives 115A and 116A of the second slotter heads 36A, and thus, grooves 324k and 324m are formed at the original positions and grooves 324n and 324p are formed at the offset positions. Therefore, the rotation positions of the slotter knives 112A and 113A in the first slotter heads 35A and the rotation positions of the slotter knives 115A and 116A in the second slotter heads 36A can be known. The operator drives the drive device 120 by the operation device 242, and as shown in FIGS. 24 and 25, the operator rotates each of the second slotter heads 36A to the origin position at which a circumferential end portion of each of the slotter knives 115A is positioned at the sheet transport line L.

Returning to FIG. 18, in Step S26, the control device 241 moves the second slotter heads 36A and the third slotter heads 37A via the movement frames 223 in the axial direction by the movement device 230 and stops the slotter heads 36A and 37A at the original positions. In addition, in Step S27, the rotation position of each of the slotter heads 35A, 36A, and 37A in which the slotter knives 113A, 115A, and 119A are positioned at the origin positions is stored. In this case, the slotter knives 113A, 115A, and 119A are respectively fixed to the slotter heads 35, 36, and 37, the slotter knives 112A, 116A, and 118A are respectively adjustable in position with respect to the slotter heads 35, 36, and 37, and thus, the slotter knives 113A, 115A, and 119A fixed to the slotter heads 35, 36, and 37 are positioned.

In Step S26, when the control device 241 controls the movement device 230 so as to move the second slotter heads 36A and the third slotter heads 37A in the axial direction and returns the heads 36A and 37A to the original positions so as to stop the heads 36A and 37A, the control of the first embodiment may be performed.

Thereafter, if the rotation position determination processing of each of the slotter heads 35A, 36A, and 37A is completed, the control device 241 drives the slotter apparatus 100 by the drive device 120 to trially slice the corrugated fiberboard S. The operator checks whether or not the shape, the dimensions, or the like of the groove of the processed corrugated fiberboard S are appropriate.

Thereafter, a relative rotation position between the slotter heads 35, 36, and 37 is adjusted according to the type of the corrugated fiberboard S to be processed, and the position of each of the slotter knives 112A, 116A, and 118A is adjusted.

In this way, in the slotter apparatus of the second embodiment, when the adjustment mode in which each of the several slotter knives 112, 113, 115, 116, 118, and 119 is positioned at the predetermined position set in advance is selected, the control device 241 which controls the drive device 120 is provided.

Accordingly, if the axial adjustment mode is selected, the control device 241 moves the slotter heads 35, 36, and 37 having the slotter knives 112, 113, 115, 116, 118, and 119 in the rotational axis direction by the drive device 120 so as to position each of the slotter heads 35, 36, and 37 at the predetermined position set in advance. Accordingly, it is possible to position each of the slotter knives 112, 113, 115, 116, 118, and 119 at the desired position at an early stage, and it is possible to improve efficiency of the position adjustment work.

In the slotter apparatus of the second embodiment, the adjustment mode is the circumferential adjustment mode in which each of the several slotter heads 35, 36, and 37 is rotated to the origin position, at which the end portion of each of the slotter knives 113, 115, and 119 is positioned at the sheet transport line L, by the drive device 120.

Accordingly, if the circumferential adjustment mode is selected, the control device 241 rotates each of the slotter heads 35, 36, and 37 to the origin position by the drive device 120, and thus, each of the slotter knives 113, 115, and 119 is positioned at the origin position once when the circumferential positions of the slotter knives 112, 113, 115, 116, 118, and 119 are not known.

Accordingly, it is possible to position each of the slotter knives 112, 113, 115, 116, 118, and 119 at the desired position at an early stage.

In the slotter apparatus of the second embodiment, in the circumferential adjustment mode, the control device 241 moves one slotter head 35, 36, or 37 of the slotter heads 35, 36, and 37 to the predetermined position in the rotational axis direction by the movement device 230, drivingly rotates the slotter heads 35, 36, and 37 and the lower blades 40, 41, and 42 by the drive device 120 so as to slice the corrugated fiberboard S, and rotates each of the slotter heads 35, 36, and 37 to the origin position based on the sheet processed shape. Accordingly, the slotter heads 35, 36, and 37 are drivingly rotated and the corrugated fiberboard is sliced in the state where one slotter head 35, 36, or 37 is moved to the predetermined position, and thus, the grooves processed by the slotter knives 112, 113, 115, 116, 118, and 119 are individually formed on the corrugated fiberboard S, and it is possible to ascertain the current circumferential position of each of the slotter knives 112, 113, 115, 116, 118, and 119 with respect to the slotter heads 35, 36, and 37. In addition, each of the slotter heads 35, 36, and 37 is rotated to the origin position, and thus, it is possible to easily position each of the slotter knives 112, 113, 115, 116, 118, and 119 at the desired position after each of the slotter heads 35, 36, and 37 is rotated to the origin position.

In the slotter apparatus of the second embodiment, the control device 241 stops the driving rotation performed by the drive device 120 with respect to the slotter heads 35, 36, and 37, which is not subjected to the position adjustment, in the slotter heads 35, 36, and 37. Accordingly, the slicing by slotter heads 35, 36, and 37 which is not trying to ascertain the circumferential position with respect to the corrugated fiberboard S is not performed, and it is possible to process the groove of only the slotter heads 35, 36, and 37 which is trying to ascertain the circumferential position with respect to the corrugated fiberboard S.

In the slotter apparatus of the second embodiment, after the control device 241 positions each of the slotter heads 35, 36, and 37 having the slotter knives 112, 113, 115, 116, 118, and 119 at a predetermined position, the control device 241 drivingly rotates the slotter heads 35, 36, and 37 and the lower blades 40, 41, and 42 by the drive device 120 and trially slices the corrugated fiberboard S. Accordingly, it is possible to check the positioning accuracy of each of the slotter knives 112, 113, 115, 116, 118, and 119.

In addition, the slotter positioning method of the second embodiment includes a step of moving at least one slotter head 35, 36, or 37 of several slotter heads 35, 36, and 37 on which the slotter knives 112, 113, 115, 116, 118, and 119 are mounted to a work position offset in a rotational axis direction, a step of rotating the several slotter heads 35, 36, and 37 to slice the corrugated fiberboard S, a step of rotating, based on a sheet processed shape, at least the slotter heads 35, 36, and 37 positioned the work position to an origin position at which an end portion of each of the slotter knives 112, 113, 115, 116, 118, and 119 is positioned at a sheet transport line, and a step of moving the slotter heads 35, 36, and 37 positioned at the work positions in the rotational axis direction so as to return the slotter heads 35, 36, and 37 to the original positions.

Accordingly, if the several slotter heads 35, 36, and 37 are rotated to slice the corrugated fiberboard S in a state where one of the slotter heads 35, 36, and 37 is moved to the work position, a processing groove is formed on the corrugated fiberboard S for each slotter knife 112, 113, 115, 116, 118, or 119, and each of the slotter heads 35, 36, and 37 is rotated to the origin position according to the position of the processing groove. Therefore, it is possible to accurately position each of the slotter knives 112, 113, 115, 116, 118, and 119 at the desired position based on the origin position, and it is possible to improve the efficiency of the position adjustment work of each of the slotter knives.

Moreover, a corrugated fiberboard S of the second embodiment includes several creasing lines, several opening grooves, several through-grooves, and several gluing margin strips which are provided at preset positions, in which the opening groove or the through-groove is formed at a position other than the preset positions. Accordingly, the opening groove or the through-groove is formed at the position other than the preset positions, and thus, it is possible to easily detect the current circumferential position of each of the slotter knives 112, 113, 115, 116, 118, and 119 with respect to each of the slotter heads 35, 36, and 37.

In addition, the circumferential lengths of the slotter knives 112, 113, 115, 116, 118, and 119 described in the above-described embodiments are not limited to the embodiments, and the circumferential lengths may be appropriately set according to the size, the shape, or the like of the corrugated fiberboard S to be processed.

In addition, in the above-described embodiment, the carton-forming machine 10 is configured of the sheet feeding section 11, the printing section 21, the slotter creaser section 31, the die-cut section 51, the cutting section 61, the speed-increasing section 71, the folding section 81, and the counter-ejector section 91. However, in a case where the hand hole is not required in the corrugated fiberboard S, the die-cut section 51 may not be omitted. In addition, the carton-forming machine 10 may be configured of the sheet feeding section 11, the printing section 21, and the slotter creaser section 31. Moreover, in the carton forming machine 10, the cutting section 61 or the speed-increasing section 71 may be omitted, and the corrugated fiberboard S may be cut in a post-process in which the corrugated fiberboard S is discharged from the carton forming machine 10.

### REFERENCE SIGNS LIST

11: sheet feeding section
21: printing section
31: slotter creaser section
34: slitter head
35, 35A, 35B: first slotter head (blade-attached slotter head)
36, 36A, 36B: second slotter head (blade-attached slotter head)
37, 37A, 37B: third slotter head (blade-attached slotter head)
40: first lower blade (receiving slotter head)
41: second lower blade (receiving slotter head)
42: third lower blade (receiving slotter head)
51: die-cut section
61: cutting section
71: speed-increasing section
81: folding section
91: counter-ejector section
100, 100A: slotter apparatus
101, 102, 103, 104: roll shaft
105, 106, 107, 108, 109, 110: slotter shaft (rotating shaft)
111: slitter knife
112, 112A, 112B: first slotter knife
113, 113A, 113B: second slotter knife
115, 115A, 115B: third slotter knife
116, 116A, 116B: fourth slotter knife
118, 118A, 118B: fifth slotter knife
119, 119A, 119B: sixth slotter knife
120: drive device
121: first drive unit
122: second drive unit
123: third drive unit
124, 125, 126: first drive transmission system
127, 128, 129: second drive transmission system
131, 132, 133: clutch (driving force disconnection unit)
134, 135, 136: encoder
201: first frame
202: second frame
211, 221: supporting shaft
212, 222: screw shaft
213, 223: movement frame (movement adjusting member)
214, 224, 226: circumferential groove
215, 225, 227: engagement piece (connection member)
230: movement device
231: fourth drive unit
232: fifth drive unit
233, 234: encoder
241: control device
242: operation device
311: cut position
312, 313, 314, 315: creasing line
321a, 321b: end portion
322, 323, 324: communication groove
322a, 322b, 322c, 322d, 323a, 323b, 323c, 323d, 324a,
324b, 324c, 324d: groove
325a, 325b, 325c, 325d: end portion
326a, 326b: gluing margin strip

1. A slotter apparatus, comprising:
a plurality of blade-attached slotter heads which include slotter knives mounted on outer peripheral portions of the blade-attached slotter heads, are rotatably supported, and are disposed along a sheet transport direction;
a plurality of receiving slotter heads which are rotatably supported, are disposed to face the plurality of blade-attached slotter heads, and are disposed in the sheet transport direction in series;
a drive device which drivingly rotates the plurality of blade-attached slotter heads and the plurality of receiving slotter heads;
a movement device configured to the plurality of blade-attached slotter heads and the plurality of receiving slotter heads in a rotational axis direction; and
a control device configured to control the drive device or the movement device when an adjustment mode in which each of a plurality of the slotter knives is positioned at a predetermined position set in advance is selected.

2. The slotter apparatus according to claim 1,
wherein the drive device includes a first drive transmission system which drivingly rotates the blade-attached slotter heads, a second drive transmission system which drivingly rotates the receiving slotter heads, and a driving force disconnection unit which is provided in the first drive transmission system.

3. The slotter apparatus according to claim 2,
wherein the drive device includes a plurality of drive units which drivingly rotates the plurality of blade-attached slotter heads independently.

4. The slotter apparatus according to claim 1,
wherein the blade-attached slotter heads are supported to be moved relative to each other in the rotational axis direction and to be integrally rotated in a circumferential direction, the receiving slotter heads are supported to be moved relative to each other in the rotational axis direction and to be integrally rotated in the circumferential direction, the movement device includes movement adjusting members, each of which can be moved in a direction parallel to the rotational axis direction, and connection members which can connect the movement adjusting members, and the blade-attached slotter heads and the receiving slotter heads to each other.

5. The slotter apparatus according to claim 1,
wherein the adjustment mode is an axial adjustment mode in which the plurality of blade-attached slotter heads are moved to the same position as each other in the rotational axis direction by the movement device.

6. The slotter apparatus according to claim 5,
wherein in the axial adjustment mode, the control device moves blade-attached slotter heads other than a blade-attached slotter head disposed on the most upstream side in the sheet transport direction in the plurality of blade-attached slotter heads to a movement position of the blade-attached slotter head disposed on the most upstream side, by the movement device.

7. The slotter apparatus according to claim 6,
wherein when each of the plurality of blade-attached slotter heads is moved to a preset target position and a positional deviation in the rotational axis direction at each movement position of the plurality of blade-attached slotter heads is not within a predetermined range set in advance, the control device moves blade-attached slotter heads other than the blade-attached slotter head disposed on the most upstream side to the movement position of the blade-attached slotter head disposed on the most upstream side.

8. The slotter apparatus according to claim 1,
wherein the adjustment mode is a circumferential adjustment mode in which each of the plurality of blade-attached slotter heads is rotated to an origin position, at which an end portion of the slotter knife is positioned at a sheet transport line, by the drive device.

9. The slotter apparatus according to claim 8,
wherein in the circumferential adjustment mode, the control device moves one of the plurality of blade-attached slotter heads to a predetermined position in the rotational axis direction by the movement device, drivingly rotates the plurality of blade-attached slotter heads and the plurality of receiving slotter heads by the drive device so as to slice the sheet, and rotates each of the plurality of blade-attached slotter heads to the origin position based on a sheet processed shape.

10. The slotter apparatus according to claim 9,
wherein the control device stops a driving rotation performed by the drive device with respect to the blade-attached slotter head, which is not subjected to a position adjustment, in the plurality of blade-attached slotter heads.

11. The slotter apparatus according to claim 1,
wherein after the control device positions each of the plurality of slotter knives at a predetermined position, the control device drivingly rotates the plurality of blade-attached slotter heads and the plurality of receiving slotter heads by the drive device and trially slices a sheet in test.

12. (canceled)

13. (canceled)

14. A carton-forming machine comprising:
a sheet feeding section which supplies a sheet;
a printing section which performs printing on the sheet;
a slotter creaser section having the slotter apparatus according to claim 1 which performs creasing line processing and slicing on the printed sheet;
a cutting section which cuts the sheet subjected to the creasing line processing and the slicing, at an intermediate position of the sheet in a transport direction;
a folding section which folds the cut sheet and joins an end portion of the sheet to form a carton body; and
a counter-ejector section which stacks the carton bodies while counting the carton bodies, and thereafter, discharges the carton bodies for each predetermined number.

15. A corrugated fiberboard, comprising:
a plurality of creasing lines, a plurality of opening grooves, a plurality of through-grooves, and a plurality of gluing margin strips which are provided at preset positions,
wherein the opening groove or the through-groove is formed at a position other than the preset positions.
